(19) United States
(12) Patent Application Publication
(10) Pub. No.: US 2021/0295217 A1
(43) Pub. Date: Sep. 23, 2021

(54) FACILITY RESERVATION SYSTEM, INFORMATION PROCESSING TERMINAL, AND INFORMATION PROCESSING APPARATUS

(71) Applicant: YUKI NAGAHARA, Kanagawa (JP)

(72) Inventor: YUKI NAGAHARA, Kanagawa (JP)

(73) Assignee: Ricoh Company, Ltd., Tokyo (JP)

(21) Appl. No.: 17/193,308

(22) Filed: Mar. 5, 2021

(30) Foreign Application Priority Data
Mar. 23, 2020 (JP) 2020-051372

(51) Int. Cl. G06Q 10/02; G06Q 10/06; G06F 16/955; G06F 16/904; H04L 29/06; G06F 3/0482

(52) U.S. Cl. CPC G06Q 10/02; G06Q 10/06315; G06F 16/9566; G06Q 10/1095; H04L 63/083; G06F 3/0482; G06F 16/904

(57) ABSTRACT

A facility reservation system, an information processing terminal, and an information processing apparatus. The facility reservation system transmits to the information processing apparatus, a request to start using the facility, the request designating information related to a reservation of the facility to be used in response to receiving an operation to start using the facility, permits start of use of the facility in response to receiving the request to start using the facility, identify electronic data output during the use of the facility based on the information related to the reservation of the facility in response to permitting the start of use of the facility, and transmits information for displaying the electronic data to the information processing terminal.

### CROSS-REFERENCE TO RELATED APPLICATIONS

This patent application is based on and claims priority pursuant to 35 U.S.C. § 119(a) to Japanese Patent Application No. 2020-051372, filed on Mar. 23, 2020, in the Japan Patent Office, the entire disclosure of which is hereby incorporated by reference herein.

### BACKGROUND

### Technical Field

The present disclosure relates to a facility reservation system, an information processing terminal, and an information processing apparatus.

### Related Art

A facility reservation system for reserving facilities such as meeting rooms is known. In a general facility reservation system, a user can operate a terminal device connected to a reservation management server through a network to reserve a meeting room. An information processing terminal installed in the meeting room or the like communicates with the information processing apparatus (server) and displays the schedule and place of a meeting. The user uses the meeting room by inputting start of use of a reserved facility into the information processing terminal. At the end of use, the end of use of the facility is input to the information processing terminal.

### SUMMARY

Embodiments of the present disclosure describe a facility reservation system, an information processing terminal, and an information processing apparatus. The facility reservation system transmits to the information processing apparatus, a request to start using the facility, the request designating information related to a reservation of the facility to be used in response to receiving an operation to start using the facility, permits start of use of the facility in response to receiving the request to start using the facility, identify electronic data output during the use of the facility based on the information related to the reservation of the facility in response to permitting the start of use of the facility, and transmits information for displaying the electronic data to the information processing terminal.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an overview of operation performed by a facility reservation system, according to embodiments of the present disclosure;

FIG. 2 is a block diagram illustrating an example of a system configuration of the facility reservation system according to embodiments of the present disclosure;

FIG. 3 is a block diagram illustrating an example of a hardware configuration of a meeting management server according to embodiments of the present disclosure;

FIG. 4 is a block diagram illustrating an example of a hardware configuration of a meeting room terminal, according to embodiments of the present disclosure;

FIG. 5 is a block diagram illustrating an example of a hardware configuration of an electronic whiteboard, which is an example of an electronic device, according to embodiments of the present disclosure;

FIGS. 6A and 6B are block diagrams illustrating functional configurations of a reservation management server, a chat server, and a meeting management server according to embodiments of the present disclosure;

FIGS. 7A and 7B are block diagrams illustrating functional configurations of the terminal device and the meeting room terminal according to embodiments of the present disclosure;

FIG. 8 is a block diagram illustrating a functional configuration of the electronic device according to embodiments of the present disclosure;

FIG. 9 is a sequence diagram illustrating an example of a process from reservation of a meeting room to display of a reservation status screen according to embodiments of the present disclosure;

FIG. 10 is a diagram illustrating an example of the reservation status screen displayed by the meeting room terminal according to embodiments of the present disclosure;

FIG. 11 is a sequence diagram illustrating an example of a process performed by the facility reservation system when a user checks out according to embodiments of the present disclosure;

FIG. 12 is a sequence diagram illustrating an example of a process performed by the facility reservation system when the user checks in according to embodiments of the present disclosure;

FIG. 13 is a diagram illustrating an example of a list screen of reservation information displayed by the meeting room terminal according to embodiments of the present disclosure;

FIG. 14 is a diagram illustrating a display example of electronic data displayed by the electronic device according to embodiments of the present disclosure;

FIG. 15 is a diagram illustrating a display example of electronic data displayed by the terminal device according to embodiments of the present disclosure;

FIG. 16 is a sequence diagram illustrating an example of a process performed by the facility reservation system when the user checks in (modification example) according to embodiments of the present disclosure;

FIG. 17 is a sequence diagram illustrating an example of a process performed by the facility reservation system when the user checks out according to embodiments of the present disclosure; and

FIG. 18 is a sequence diagram illustrating an example of a process performed by the facility reservation system when the user checks in, according to embodiments of the present disclosure.

The accompanying drawings are intended to depict embodiments of the present invention and should not be interpreted to limit the scope thereof. The accompanying drawings are not to be considered as drawn to scale unless explicitly noted. Also, identical, or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, as an example of a mode for carrying out the present disclosure, a facility reservation system, an electronic data providing process performed by the facility reservation system, an information processing process performed by an information processing terminal, and a data transmission process performed by an information processing apparatus (meeting management server) are described.

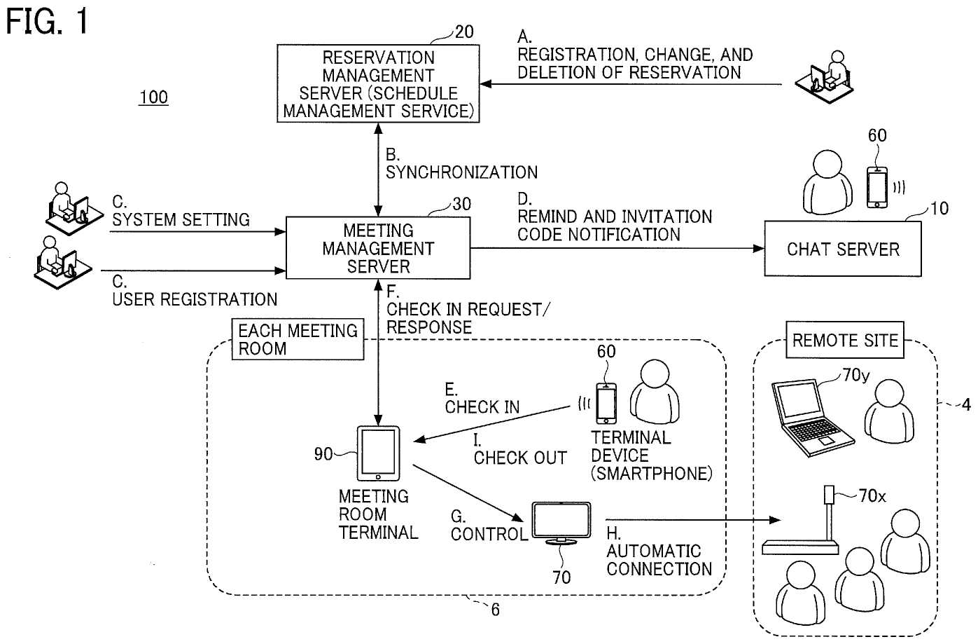

The outline of the facility reservation system is described with reference to FIG. 1. FIG. 1 is a block diagram illustrating an overview of operation performed by a facility reservation system 100.

A. A reservation-making user (user who makes a reservation) operates a user's terminal device to communicate with a reservation management server 20, whereby reserving a meeting room. The reservation management server 20 is a general-purpose cloud service such as OFFICE 365 (registered trademark) and G SUITE (registered trademark) and a meeting room owned by an organization such as a company to which the reservation-making user belongs is registered.

B. A meeting management server 30 is a server that controls entire operation of the facility reservation system 100 based on reservation status of the meeting rooms. The meeting management server 30 communicates with the reservation management server 20 at suitable timings to acquire reservation information, in order to synchronize the reservation information between the meeting management server 30 and the reservation management server 20.

C. An administrator or the like of the organization or the facility reservation system 100 performs user registration and configures various settings to the meeting management server 30. The user registration refers to registering a user to whom various notifications are to be sent by a chat server 10 such as SLACK (registered trademark), LINE (registered trademark), and MICROSOFT TEAMS (registered trademark). Further, since the notification is performed through a bot that sends a message as the meeting management server 30, the bot provided by the chat server is also registered. Examples of the various settings configured by the administrator or the like to the meeting management server 30 include registration of a meeting room terminal 90 and a setting of a timing when a reminder is to be sent.

D. When current time is a fixed time period before the start time of a meeting defined in the reservation information, the meeting management server 30 sends a reminder of a scheduled meeting to the reservation-making user, thereby reducing an empty reservation of a meeting room. The “empty reservation” refers to reserving resources such as the meeting room that is not actually used. Further, the meeting management server 30 sends a notification indicating an invitation code (meeting identification information) to the user as needed. In response to receiving the reminder, the reservation-making user stores the invitation code for checking in to the meeting room in the terminal device 60.

E. A meeting room terminal 90 (an example of an information processing terminal) is provided in each meeting room 6, and the meeting room terminal 90 downloads reservation information for meetings held in the meeting room on a regular basis. The meeting room terminal 90 displays schedule of meetings to be held on the current day or the schedule of the upcoming meetings, thereby allowing participants of the meeting to confirm the schedule. One meeting room terminal 90 may be arranged in common for a plurality of meeting rooms. The reservation-making user of the meeting room enters the meeting room 6 a little before the start time of the meeting to check-in. For example, the meeting identification information is input to the meeting room terminal 90, or the terminal device 60 is held over the meeting identification information (the meeting identification information is read, communicated, etc.). Such an operation is called a check-in operation, and the check-in operation is an operation to start using the meeting room.

Also, at the check-in, the meeting room terminal 90 receives from the meeting management server 30, information for displaying electronic data output during use of the facility at a previous (or past) meeting (information for displaying electronic data includes the electronic data itself) identified based on the detected reservation information. The meeting room terminal 90 transmits information for displaying electronic data to the electronic device 70, and the electronic device 70 displays the electronic data. Alternatively, the meeting management server 30 may transmit electronic data to the user's terminal device 60. As described above, the user can check-in with one check-in operation and further display the electronic data used in the past meetings and the like.

F. The meeting room terminal 90 transmits the check-in request (usage start request) to the meeting management server 30, and if the meeting room terminal 90 is authenticated with the meeting identification information, the meeting room terminal 90 receives a response indicating that the check-in has succeeded from the meeting management server 30. The meeting room terminal 90 displays that the meeting room is in session (in use). If the check-in cannot be confirmed within a fixed time of the start time of the meeting, the meeting management server 30 cancels the reservation of the meeting room 6 (automatic cancellation), and transmits the automatic cancellation as the status included in the reservation information to the meeting room terminal 90. In this case, since the meeting room terminal 90 displays information indicating that the meeting room is vacant, any user can use the meeting room 6.

G. The meeting room terminal 90 controls the electronic device 70 in response to a request from the meeting management server 30. For example, the meeting room terminal 90 controls the electronic device 70 so that the power is turned on at the start time of the meeting or when checking in and turned off at the end time of the meeting or when checking out. As described above, it is possible to improve the convenience when the participants of the meeting use the electronic device 70.

H. When the electronic device 70 includes, for example, a videoconferencing function, the electronic device 70 communicates with an electronic device such as a videoconferencing terminal 70x at a remote site 4 to conduct a meeting (video meeting). Note that a personal computer (PC) 70y on which an application operates can also communicate with the electronic device 70. The reservation information includes destination information (communication identifier (ID) of a communication destination) indicating the remote site 4 in advance. The electronic device 70 automatically communicates with the videoconferencing terminal 70x and the PC 70y by using the destination information.

I. When the reservation-making user ends the meeting, the user presses a button of the meeting room terminal 90 to check-out. The meeting room terminal 90 displays the next reservation status. As a result, any user is allowed to check the reservation status of the meeting room.

At the time of check-out, the meeting room terminal 90 communicates with the electronic device 70 and the like, and collects information for displaying the electronic data used during the meeting (including the electronic data itself). The information for displaying the electronic data is transmitted to the meeting management server 30. The meeting management server 30 stores information for displaying the electronic data in association with the reservation information. As a result, at the time of check-in, the meeting management server 30 can provide the user with information for displaying the electronic data associated with the past reservation information based on the reservation information.

As described above, the facility reservation system of the present embodiment can provide the user with the electronic data used in the past meeting by the user who checked in to the meeting room. As described above, the user can check-in with one check-in operation and further display the electronic data used in the past meetings and the like. Since the meeting room terminal 90 displaying the entry button (display part) described below is waiting for check-in, the display of electronic data by a user who is not related to the meeting can be prevented.

A facility is a resource that is subject to reservation. For example, meeting rooms, equipment that can be used in the meeting rooms, apparatuses, people (groups), company cars, bicycles, parking lots and bicycle parking lots, free addresses, desks, booths, remote meeting systems, printing services, and mechanisms are also facilities. In the present embodiment, for the sake of explanatory convenience, the term “meeting room” is used as an example of the facility. In addition, as examples of facilities, various electronic devices, places such as parking lots, rental offices, rental studios, rental cycles, rental cars (sharing cars), accommodation facilities such as hotels, various facilities such as entertainment venues, rental lockers, and rental spaces may be included.

The reservation-making user is the person who reserved the meeting room, and a participant is a participant in the meeting. The reservation-making user is often included in the participants but may not be included. In the present embodiment, work performed by the reservation-making user may be performed by the participant. Persons who use the meeting room are simply called users.

The check-in indicates that the meeting management server 30 receives a request to start using the facility, and the user is allowed to start using the facility. Generally, in order for check-in to be permitted, the meeting management server needs to confirm that the person is a legitimate reservation-making user or participant. From the user's point of view, if the user can check-in, the user is allowed to use the facility.

The check-out indicates that the meeting management server 30 receives the end of use, extinguishes the right to use the facility granted to the user, and opens the facility.

The electronic data output during the use of the facility is the data on the user side output from the start to the end of the use of the facility. The electronic data output during the use of the facility includes, for example, the electronic data displayed during the use of the facility, the created electronic data, the recorded electronic data, the edited electronic data, the referenced electronic data, and the like. The electronic data output during the use of the facility is mainly output in the meeting room regardless of device or operation. The electronic data output during the use of the facility does not have to include electronic data output by the facility reservation system such as reservation information because the electronic data is on the user side, but the electronic data output by the facility reservation system may be included. The electronic data includes, for example, data handwritten on the display of the electronic device 70 or the user terminal, voice data by utterance, a file or web page viewed by the electronic device or the terminal device, or meeting minutes generated from these data. In the present embodiment, the electronic data is simply described by the term “used electronic data”.

The information related to reservation is information that identifies the reservation information of the facility. In the present embodiment, the term “reservation ID” is used.

The reservation information is information for managing the reservation status (reservation schedule) of the facility, and at least from when to when the reservation is made can be known. In addition, the reservation information may include equipment such as a projector, a reservation-making user, a meeting name, and a prospective participant.

The information for displaying the electronic data is information needed to display the electronic data on the user's terminal or the device in the facility. The information for displaying the electronic data includes a storage location such as a uniform resource locator (URL), or one or more passwords indicating viewing authority in addition to the electronic data.

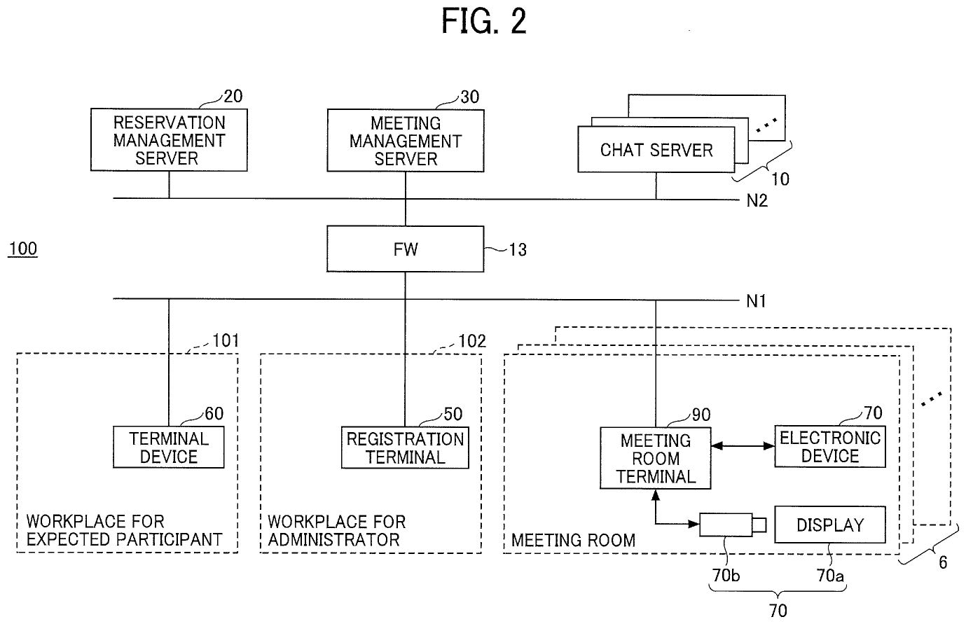

FIG. 2 is a block diagram illustrating an example of a system configuration of the facility reservation system 100. The facility reservation system 100 is divided into an external network N2 and an intra-company network N1. The intra-company network N1 refers to a network inside a firewall 13, and the external network N2 is a network such as the internet through which unspecified volume of communication is transmitted.

The reservation management server 20, the meeting management server 30, and one or more chat servers 10 are connected to the external network N2. The servers communicate with one another as needed. The terminal device 60 operated by the participant of the meeting may be connected to the external network N2 as needed.

The reservation management server 20 is implemented by one or more information processing apparatuses (a computer system), each being installed with a general-purpose server operating system (OS) or the like. A system relating to the reservation of a facility, provided by the reservation management server 20, is referred to as a reservation management system. The reservation management server 20 includes a calendar system and provides a web application for managing various schedules. Specifically, the web application provides the following functions, for example.
To accept schedule registration and enable the reservation-making user to confirm the reservation from anywhere at any time.
To send a reminder email at the preset date and time, such as 30 minutes before the scheduled time.
To enable one person to manage schedules using plural calendars (for business, for private, etc.).
To share a calendar with users belonging to the same group.

The reservation management server 20 manages a user using an account. The account refers to a right for a user to use a service. In many systems, the user logs in to a system using the account. For this reason, the account has a function (function of identification information) to enable the system to uniquely identify the user. In the present embodiment, the reservation management server 20 transmits reservation information of the account (domain) registered in advance to the meeting management server 30. Alternatively, the meeting management server 30 requests the reservation information by designating the account of the reservation management server 20, to acquire the reservation information of the meeting room 6 from the reservation management server 20. The account can be any suitable information based on which a user can be uniquely identified. Examples of the account include an email address, an ID, and a telephone number.

Although in the present embodiment, the reservation management server 20 manages the reservation of each meeting room 6 as a schedule, the reservation management server 20 is configured to manage various types of schedules in addition to the reservation of each meeting room 6. The reservation management server 20 can be used for reservations for various types of facilities other than the meeting room 6, such as a reservation for rental of various electronic devices, a reservation for a parking lot, a rental office, a rental studio, a rental bicycle, a rental car, accommodation facilities such as hotels, a rental space such as event venues and lockers.

Although G SUITE (registered trademark), OFFICE 365 (registered trademark), and the like are known as reservation management systems, any other suitable reservation management system having functions described in the present embodiment will suffice.

Further, in the present embodiment, information relating to the one or more meeting rooms 6 within the intra-company network N1 is registered in advance with the reservation management server 20. In other words, the web application of the reservation management server 20 is customized according to a meeting room name, a meeting room ID, a reservation available time, a capacity, a unit of reservation and the like of each meeting room 6 residing within the intra-company network N1 of a company using the facility reservation system 100. Accordingly, each meeting room 6 of the company using the facility reservation system 100 is associated with the reservation information.

The chat server 10 is implemented by one or more information processing apparatuses (computer system), each being installed with a general-purpose server OS or the like. A system for real-time sharing of information such as text, audio, and video by a plurality of users provided by the chat server 10 is referred to as a chat system. The chat server 10 notifies the terminal device 60 of the information related to the reservation of the meeting room 6. In the present embodiment, the facility reservation system 100 may include a plurality of chat servers 10 operated by different entities respectively.

The information shared in the chat system includes image data, audio data, etc., in addition to text. In the present embodiment, a description is given of an example case in which text is mainly used for the notification, for the sake of explanatory convenience. For example, the chat system may provide a voice chat capability for the group. The voice chat may be an one-to-one voice chat or an one-to-N voice chat, where N is two or more. In other words, according to the present embodiment, the chat system notifies the information related to the reservation of the meeting room 6 by outputting a voice message, in addition to or in alterative to, displaying text. LINE (registered trademark), SLACK (registered trademark), MICROSOFT TEAMS (registered trademark) and the like are known as chat systems, but any chat system having a capability of transmitting notification to one or a plurality of users from a bot (a program that executes predetermined processes) will suffice.

The chat server 10 also manages a user by using an account, which is different from the account of the reservation management server 20. The meeting management server 30 basically does not need to recognize the account of the chat server 10. However, the meeting management server 30 can transmit a notification by designating a desired account of the chat server 10.

The meeting management server 30 is implemented by one or more information processing apparatuses (computer system), each being installed with a general-purpose server OS or the like. The meeting management server 30 is an example of an information processing apparatus in claims. As a process relating to the external network N2, the meeting management server 30 acquires the reservation information of the meeting room 6 from the reservation management server 20. Further, the meeting management server 30 acquires an expected participant set in the reservation information and transmits a notification to the group of the chat server 10 (or to an individual user such as a reservation-making user) associated with the acquired expected participant at a preset time. As a process relating to the intra-company network N1, the meeting management server 30 manages a check-in and a check-out to and from the meeting room 6. Further, the meeting management server 30 controls turning on or off of the electronic device 70, based on the reservation information of the meeting room 6 acquired from the reservation management server 20.

An expected participant can access the external network N2 through the intra-company network N1 from various locations such as the meeting room 6, a workplace 101 for an expected participant, a workplace 102 for an administrator, and the like in the intra-company network N1. Examples of the intra-company network N1 include a local area network (LAN). The meeting room 6, the workplace 101 for an expected participant, and the workplace 102 for an administrator are not necessarily in the LAN of the same company.

In the meeting room 6, the meeting room terminal 90 and the electronic device 70 are located. The meeting room terminal 90 and the electronic device 70 may communicate with each other through a small-scale LAN or a dedicated line. The electronic device 70 connects to the intra-company network N1 and the external network N2 without intervening the meeting room terminal 90. The meeting room terminal 90 and the electronic device 70 communicates with each other either wirelessly or by wire. Since the intra-company network N1 is inside the firewall 13, it is difficult to perform direct communication from the external network N2 to the intra-company network N1.

The meeting room terminal 90 is an information processing apparatus (an example of an information processing terminal) that receives operations from meeting participants such as reservation-making user who uses the meeting room 6. For example, the meeting room terminal 90 is provided on a desk in the meeting room 6 or at an entrance of the meeting room 6. A plurality of the meeting room terminals 90 may be provided in one meeting room 6. One meeting room terminal 90 may be provided in a plurality of meeting rooms 6. The meeting room terminal 90 is implemented by one or more information processing apparatuses (computer systems), each being installed with a general-purpose OS or the like.

For example, the meeting room terminal 90 transmits the meeting room ID to the meeting management server 30 to display the reservation information of the meeting room 6 of the current day. Furthermore, the meeting room terminal 90 acquires control information such as turning on or off of the electronic device 70 from the meeting management server 30. The meeting room terminal 90 turns on or off the electronic device 70 using the acquired control information.

The meeting room terminal 90 displays a reservation status screen for receiving an instruction for check-in, check-out, etc. Further, the meeting room terminal 90 communicates with the meeting management server 30, to notify the meeting management server 30 of the check-in or the check-out. In response to receiving the instruction for check-in, the meeting room terminal 90 transmits, to the meeting management server 30, meeting identification information that is input by the reservation-making user and a meeting room ID that the meeting room terminal 90 holds in advance. Based on the meeting identification information and the meeting room ID transmitted from the meeting room terminal 90, the meeting management server 30 can confirm that the user who made the reservation for the meeting room 6 uses the reserved meeting room 6.

The electronic device 70 is various office devices that may be used in the meeting room 6. The electronic device 70 is a facility to be reserved together with the meeting room 6. Examples of the electronic device 70 include an electronic whiteboard, a multifunction peripheral, a projector, a digital signage, and a digital camera. The electronic whiteboard includes a large-sized display that supports a touch panel system. The electronic whiteboard detects coordinates of a point pointed by the user on a board surface and displays a stroke by connecting the coordinates of the points. In addition, the electronic whiteboard is configured to display an image in accordance with data output from a terminal device that is connected to the electronic whiteboard. Further, the electronic whiteboard is configured to communicate with other electronic whiteboard located in a remote site to share the displayed stroke in a synchronous manner. The electronic whiteboard may be referred to as an electronic information board, etc.

The multifunction peripheral includes multiple functions such as a copier function, a scanner function, a printer function, and/or a facsimile transmitting/receiving function. The multifunction peripheral is used for printing or copying documents, scanning documents for conversion to digital data, and faxing documents during the meeting. The projector is a device that projects an image. For example, the projector projects an image (still image or moving image) displayed on a display of the terminal device 60 onto a screen, etc., to enable the participants to share the image. The digital signage is a large-sized display and is used for displaying any still images or moving images. The digital camera is used by each participant to capture an image formed on paper documents or presentation materials displayed on the electronic whiteboard for storage.

Further, the electronic device 70 may be a device in which a microcomputer 70b (one or more information processing apparatuses) is mounted on the display 70a. The microcomputer 70b communicates with the meeting room terminal 90 to turn on/off the power supply, receive information for displaying electronic data, and the like. The microcomputer 70b also enables communication with the terminal device 60. Therefore, the terminal device 60 can transmit screen data such as materials to the microcomputer 70b, and the microcomputer 70b can display the screen data on the display 70a. The display 70a preferably includes a touch panel, and the microcomputer 70b can save the stroke data handwritten by the user on the touch panel as electronic data. As described above, the electronic device 70 may be a microcomputer 70b and a display 70a.

The terminal device 60 that is configured to connect to the intra-company network N1 is provided in the workplace 101 for an expected participant. The terminal device 60 may communicate by wire or wirelessly. The terminal device 60 is an information processing apparatus used when an expected participant (including a reservation-making user) reserves a meeting room. The expected participant (including the reservation-making user) may also use the terminal device 60 in the meeting room. In other words, the terminal device 60 is an information processing apparatus carried by the expected participant.

The terminal device 60 is implemented by one or more information processing apparatuses (computer system), each being installed with a general-purpose OS or the like. Examples of the terminal device 60 include a smartphone, a tablet terminal, a PC, a personal digital assistant (PDA), a wearable PC such as smart glasses and a smartwatch. Further, the terminal device 60 may be any suitable device, terminal, or apparatus, provided that the device, terminal, or apparatus includes a communication capability and browser software, or application software dedicated to the chat server 10 or the reservation management server 20 operates on the device, terminal, or apparatus. For example, the terminal device 60 may be a car navigation system, a game machine, a television receiver, and the like.

In the terminal device 60, application software dedicated to the chat server 10 and application software dedicated to the facility reservation system 100 operate. The application software dedicated to the chat server 10 is referred to as a “chat application” hereinafter. The application software dedicated to the facility reservation system 100 is referred to as a “meeting application” hereinafter. Browser software may be substituted for either one or both of the chat application and the meeting application.

The registration terminal 50 configured to connect to the intra-company network N1 is provided in the workplace 102 for administrator. The registration terminal 50 may communicate by wire or wirelessly. The registration terminal 50 is an information processing apparatus for the administrator to make initial settings to the meeting room terminal 90.

The registration terminal 50 is implemented by the similar or substantially the similar information processing apparatus(es) that is implemented as the terminal device 60. However, since the registration terminal 50 is used mainly by the administrator for configuring settings to the meeting management server 30, the chat application and the meeting application may be omitted from the registration terminal 50. The registration terminal 50 communicates with the meeting management server 30 mainly by browser software.

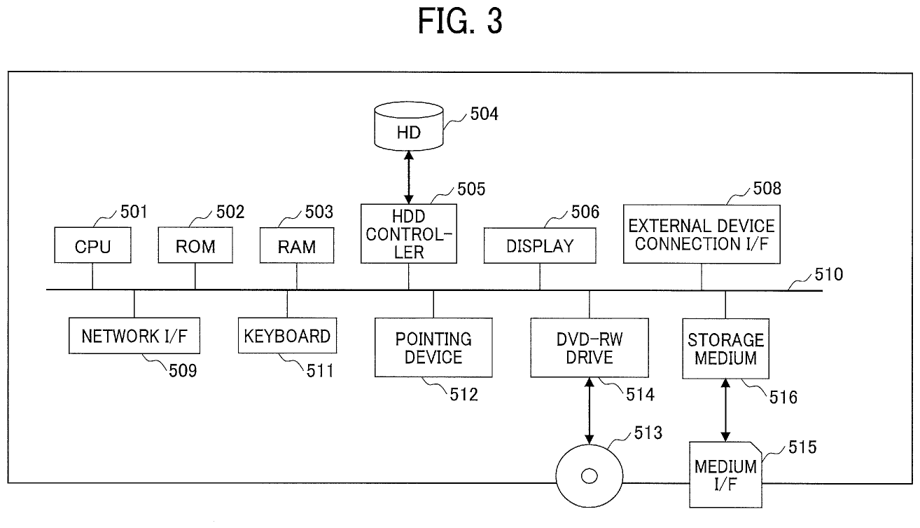

FIG. 3 is a block diagram illustrating an example of a hardware configuration of a meeting management server 30. FIG. 3 is an example of a schematic hardware configuration diagram of the meeting management server 30. The meeting management server 30 is implemented by a computer as illustrated in FIG. 3 including a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disc rewritable (DVD-RW) drive 514 and a medium I/F 516.

Among these elements, the CPU 501 controls entire operation of the meeting management server 30. The ROM 502 stores a program such as an initial program loader (IPL) used for driving the CPU 501. The RAM 503 is used as a work area for the CPU 501. The HD 504 stores various data such as programs. The HDD controller 505 controls reading and writing of various data from and to the HD 504 under control of the CPU 501. The display 506 displays various information such as a cursor, menu, window, character, or image. The external device connection I/F 508 is an interface for connecting various external devices. The external device in this case is, for example, a Universal Serial Bus (USB) memory or a printer. The network I/F 509 is an interface that controls data communication performed with an external device through the communication network. The bus line 510 is an address bus, a data bus, or the like for electrically connecting each component such as the CPU 501 illustrated in FIG. 3.

The keyboard 511 is an example of an input device provided with a plurality of keys for allowing a user to input characters, numerals, or various instructions. The pointing device 512 is an example of an input device that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading or writing (storage) of data to a storage medium 515 such as a flash memory.

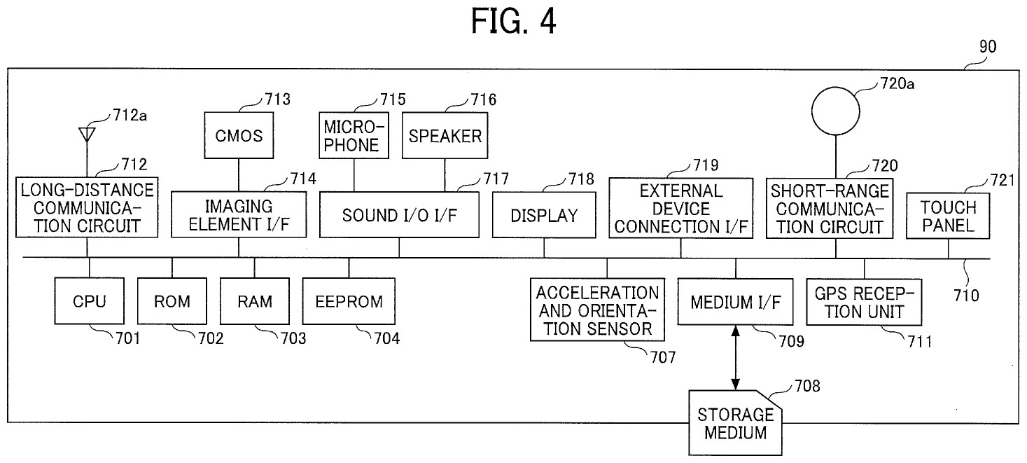

FIG. 4 is a block diagram illustrating an example of a hardware configuration of the meeting room terminal 90. FIG. 4 illustrates a hardware configuration of a tablet device, as an example of the meeting room terminal 90. As illustrated in FIG. 4, the meeting room terminal 90 includes a CPU 701, a ROM 702, a RAM 703, an electrically erasable and programmable ROM (EEPROM) 704, an acceleration and orientation sensor 707, a medium I/F 709, and a Global Positioning System (GPS) reception unit 711.

The CPU 701 controls the overall operation of the meeting room terminal 90. The ROM 702 stores programs used for driving the CPU 701 such as an initial program loader (IPL). The RAM 703 is used as a work area for the CPU 701. The EEPROM 704 reads or writes various data such as an application under control of the CPU 701. The acceleration and orientation sensor 707 includes various sensors such as an electromagnetic compass for detecting geomagnetism, a gyrocompass, and an acceleration sensor. The medium I/F 709 controls reading and writing (storing) of data from and to the storage medium 708 such as a flash memory. The GPS reception unit 711 receives a GPS signal from a GPS satellite.

Further, the meeting room terminal 90 includes a long-distance communication circuit 712, a complementary metal oxide semiconductor (CMOS) sensor 713, an imaging element I/F 714, a microphone 715, a speaker 716, a sound input and output (I/O) I/F 717, a display 718, and an external device connection IF 719, a short-range communication circuit 720, an antenna 720a of the short-range communication circuit 720, and a touch panel 721.

The long-distance communication circuit 712 is a circuit that allows communication with other devices through a communication network. The CMOS sensor 713 is an example of a built-in imaging element that captures an object (mainly, a self-image of a user operating the terminal device 60) under control of the CPU 701 to obtain image data. In alternative to the CMOS sensor, an imaging element such as a charge-coupled device (CCD) sensor may be used. The imaging element I/F 714 is a circuit that controls driving of the CMOS sensor 713. The microphone 715 is a built-in circuit that converts sound into an electric signal. The speaker 716 is a built-in circuit that generates sound such as music or voice by converting an electric signal into physical vibration. The sound I/O I/F 717 is a circuit for inputting or outputting an audio signal between the microphone 715 and the speaker 716 under control of the CPU 701. The display 718 is an example of a display device that displays an image of the object, various icons, etc. Examples of the display 718 include a liquid crystal display (LCD) and an organic electroluminescence (EL) display. The external device connection I/F 719 is an interface for connecting various external devices. The short-range communication circuit 720 is a communication circuit that communicates in compliance with the Near Field Communication (NFC), the BLUETOOTH (Registered Trademark), and the like. The touch panel 721 is an example of an input device that allows a user to operate the meeting room terminal 90 by touching a screen of the display 718.

Further, the meeting room terminal 90 includes a bus line 710. The bus line 710 is an address bus, a data bus, or the like, which electrically connects the elements in FIG. 4 such as the CPU 701.

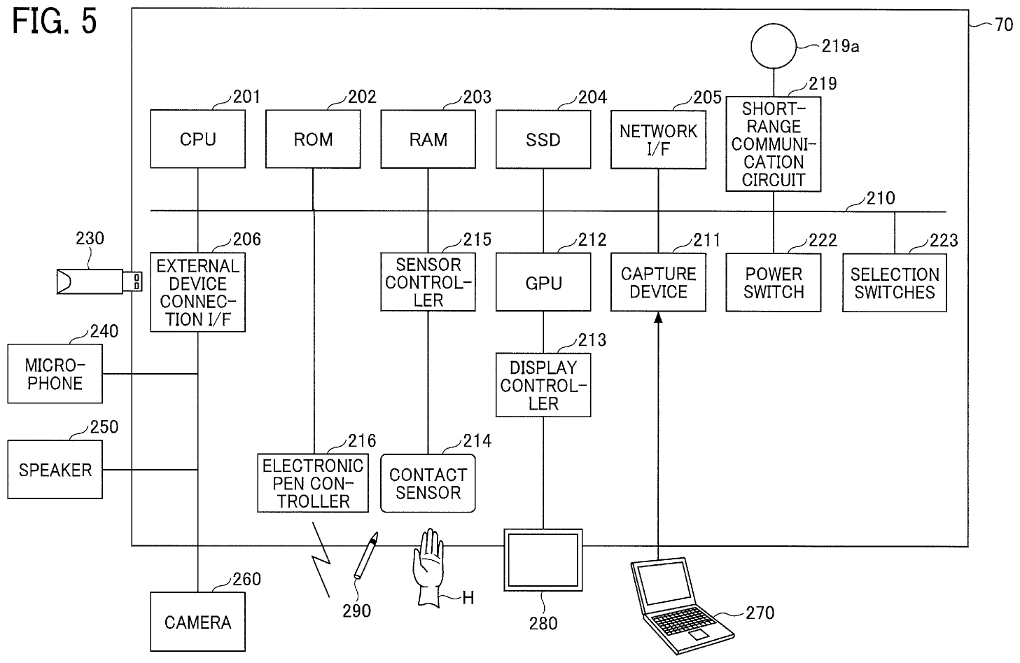

FIG. 5 is a block diagram illustrating an example of a hardware configuration of an electronic whiteboard, which is an example of an electronic device 70. As illustrated in FIG. 5, the electronic whiteboard includes a CPU 201, a ROM 202, a RAM 203, a solid state drive (SSD) 204, a network I/F 205, and an external device connection I/F 206.

The CPU 201 controls entire operation of the electronic whiteboard. The ROM 202 stores a control program such as the IPL to boot the CPU 201. The RAM 203 is used as a work area for the CPU 201. The SSD 204 stores various data such as a control program for the electronic whiteboard. The network I/F 205 controls communication with the communication network. The external device connection I/F 206 is an interface for connecting various external devices. The external devices in this case are, for example, the USB memory 230 and external devices (a microphone 240, a speaker 250, and a camera 260).

Further, the electronic whiteboard includes a capture device 211, a graphics processing unit (GPU) 212, a display controller 213, a contact sensor 214, a sensor controller 215, an electronic pen controller 216, a short-range communication circuit 219, an antenna 219a of the short-range communication circuit 219, a power switch 222, and selection switches 223.

The capture device 211 causes the display of the external PC 270 to display video data as a still image or a moving image. The GPU 212 is a semiconductor chip dedicated to processing of a graphical image. The display controller 213 controls display of an image processed by the GPU 212 for output through a display 280, and the like. The contact sensor 214 detects contact with the display 280 by an electronic pen (stylus pen) 290 or a user's hand H. The sensor controller 215 controls operation of the contact sensor 214. The contact sensor 214 performs input of coordinates and detection of coordinates by an infrared cutoff method. The light-receiving elements emit a plurality of infrared rays parallel to a surface of the display 280. The light-receiving elements receive light passing in the direction that is the same as an optical path of the emitted infrared rays, which are reflected by the reflector frame. More specifically, the display 280 is provided with two light-receiving elements disposed on both upper side ends of the display 280, and a reflector frame surrounding the sides of the display 280. The contact sensor 214 outputs an identifier (ID) of the infrared ray that is blocked by an object (such as the user's hand) after being emitted from the light-receiving elements, to the sensor controller 215. Based on the ID of the infrared ray, the sensor controller 215 detects a specific coordinate that is touched by the object. The electronic pen controller 216 communicates with the electronic pen 290 to detect contact by the tip or bottom of the electronic pen 290 with the display 280. The short-range communication circuit 219 is a communication circuit that communicates in compliance with the Near Field Communication (NFC), the BLUETOOTH (Registered Trademark), and the like. The power switch 222 turns on or off the power of the electronic whiteboard. The selection switches 223 are a group of switches for adjusting brightness, hue, etc., of display on the display 280, for example.

The electronic whiteboard further includes a bus line 210. The bus line 210 is an address bus, a data bus, or the like, which electrically connects the elements in FIG. 5 such as the CPU 201.

The contact sensor 214 is not limited to the infrared blocking system type described above and may be a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object against the display. In addition to or as an alternative to detecting contact by the tip or bottom of the electronic pen 290, the electronic pen controller 216 may also detect contact by another part of the electronic pen 290, such as a part held by a hand of the user.

When the electronic device 70 is the microcomputer 70b and the display 70a, diagram may be the same as that of a general information processing apparatus as in FIG. 3 of the meeting management server 30. Alternatively, the hardware configuration may be the same as the electronic whiteboard of FIG. 5.

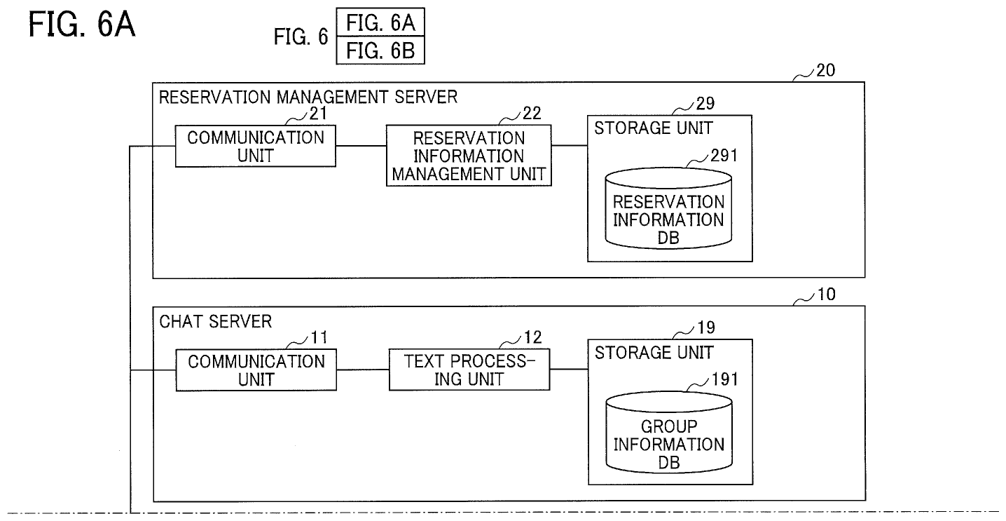

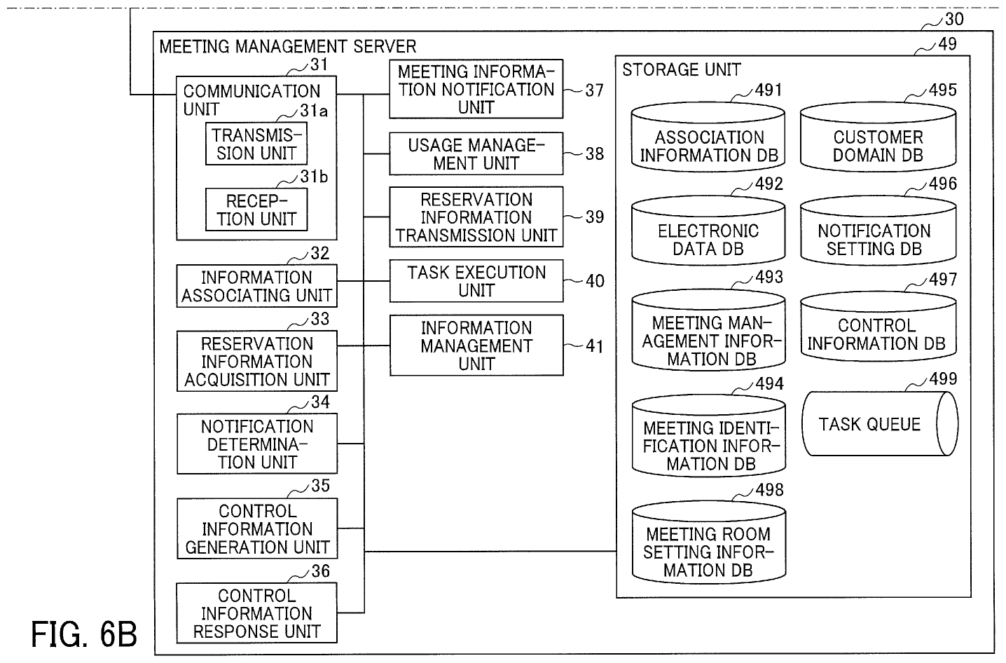

FIGS. 6A and 6B are block diagrams illustrating functional configurations of a reservation management server 20, a chat server 10, and a meeting management server 30.

The reservation management server 20 includes a communication unit 21 and a reservation information management unit 22. Each of these functional units included in the reservation management server 20 is a function implemented by operating any of the components illustrated in FIG. 3 by an instruction from the CPU 501 according to a program developed from the HD 504 to the RAM 503.

The communication unit 21 transmits and receives various types of information to and from the meeting management server 30 and the terminal device 60. The communication unit 21 transmits screen information of a reservation setting screen to the terminal device 60 and receives a reservation setting from the terminal device 60. Further, the communication unit 21 transmits reservation information to the meeting management server 30.

The reservation information management unit 22 manages reservation information registered by a user. The reservation information management unit 22 reads the reservation information of the meeting room 6 requested from the meeting management server 30 from a reservation information database (DB) 291 and transmits the reservation information to the meeting management server 30 through the communication unit 21. Alternatively, when the reservation information is registered (or changed), the reservation information is transmitted to the meeting management server 30 even if the request is not received. A general-purpose web application is used to enable an expected participant to register a reservation for a meeting room 6 in the reservation management server 20.

The reservation management server 20 further includes a storage unit 29. The storage unit 29 is implemented by the RAM 503, the HD 504, and the like of FIG. 3. The storage unit 29 stores reservation information DB 291.

TABLE 1
Reservation Information DB

| | | | | | | Expected |
|---|---|---|---|---|---|---|
| Reservation | Reservation-making | Meeting | Meeting | Start | End | participant |
| ID | user account | name | room ID | time | time | account |
| 001 | a@xfood.com | Product Z | K-001 | July 7, 2017 | July 7, 2017 | b@xfood.com |
| | | development | | 10:00 | 12:00 | c@xfood.com |
| | | meeting | | | | d@xfood.com |
| 002 | e@xfood.com | Product Y | K-001 | July 7, 2017 | July 7, 2017 | f@xfood.com |
| | | development | | 13:00 | 14:00 | g@xfood.com |
| | | meeting | | | | |
| . . . | . . . | . . . | . . . | . . . | . . . | . . . |

Table 1 is an example of reservation information stored in the reservation information DB 291. The reservation information is information for managing a reservation status of the meeting room 6. The reservation information includes, a reservation ID, an account of reservation-making user, a meeting name, a meeting room ID, a start time of the meeting, an end time of the meeting, and accounts of expected participants in association with each other. The reservation ID is identification information for identifying one record of the reservation information. ID is an abbreviation for “identifier,” and indicates an identification or identification information. ID is any one of a name, a symbol, a character string, a numerical value, or a combination of at least two of these items, which is used for identifying a particular object from among a plurality of objects. The same applies to other IDs than the reservation ID. The account of the reservation-making user is an account of an expected participant who made a reservation for the meeting room 6. The meeting name is a name of a meeting, which is given by the expected participant at participant's choice. The meeting room ID is identification information for identifying the meeting room 6 that resides on the intra-company network N1. The start time is the beginning of a time slot during which the meeting room 6 is reserved. In other words, the start time is a time when the meeting is to be started. The end time is the end of the time slot during which the meeting room 6 is reserved. In other words, the end time is a time when the meeting is to be ended. The accounts of expected participants are accounts of participants who are scheduled to attend the meeting. Each of the accounts in Table 1 is issued by the reservation management server 20.

The chat server 10 includes a communication unit 11 and a text processing unit 12. Each of these functional units included in the chat server 10 is a function implemented by operating any of the components illustrated in FIG. 3 by an instruction from the CPU 501 according to a program developed from the HD 504 to the RAM 503.

The communication unit 11 transmits and receives various types of information to and from the meeting management server 30. In the present embodiment, the communication unit 11 receives, from the meeting management server 30, information related to reservation of a meeting room, information for identifying the bot, and information identifying a group as a destination to which a notification is to be sent. Examples of the information for identifying the bot include a token described below. The information for identifying the bot is notified in advance as identification information of the bot from the chat server 10, when generating the bot of the meeting management server 30. Further, the communication unit 11 may receive information designating an account of an individual such as a reservation-making user. Furthermore, the communication unit 11 transmits, to the meeting management server 30, information indicating that an expected participant has read the information related to the reservation of the meeting room or a response made by an expected participant to the displayed information related to the reservation of the meeting room.

Based on the information transmitted from the meeting management server 30, i.e., the information identifying the bot and the information identifying the group as a destination to which the notification is to be sent, the text processing unit 12 transmits, to the expected participants belonging to the group, information related to the reservation of the meeting room 6 as information that the bot sends. When a notification destination account is further specified by the meeting management server 30, information related to the reservation of the meeting room 6 is transmitted to one of the expected participants belonging to the group. In one example, the number of notifications transmitted by the text processing unit 12 is equal to the number of the expected participants. In another example, the notification is transmitted only to the reservation-making user or only to a registered user(s).

The text processing unit 12 is configured to send a so-called “push notification”. An example of a mechanism implementing the push notification is as follows. The chat application 60a receives an ID (token) for a push notification from a server operated by a manufacturer of an OS. The server associates the token with a device (terminal device 60). The chat application 60a registers the token and an account of the chat application 60a in the chat server 10. Since the chat server 10 identifies an account of the chat application 60a when sending a push notification, the token associated with the account is identified. The chat system designates the token and transmits a notification content to the server operated by the manufacturer of the OS. The server sends a push notification to a device (terminal device 60) associated with the token.

The chat server 10 further includes a storage unit 19. The storage unit 19 is implemented by the RAM 503, the HD 504, and the like of FIG. 3. The storage unit 19 stores a group information DB 191.

TABLE 2
Group Information DB

| | | Member | Member | Member | Member | Bot |
|---|---|---|---|---|---|---|
| Workspace | Channel | account 1 | account 2 | account 3 | account 4 | account |
| http://sample.com/1 | #marketing | a@chat.com | b@chat.com | c@chat.com | d@chat.com | robo1@chat.com |
| http://sample.com/2 | #team1 | b@chat.com | d@chat.com | | | robo2@chat.com |
| http://sample.com/3 | #ip | f@chat.com | g@chat.com | h@chat.com | | robo3@chat.com |
| . . . | . . . | . . . | . . . | . . . | . . . | . . . |

Table 2 is an example of group information stored in the group information DB 191. The group information is information in which accounts of members belonging to the same group are stored. In the group information, member accounts 1 to n (n=4 in Table 2) and a bot account are registered in association with a workspace and a channel.

The workspace is identification information for identifying an organization such as a company or a department. In the present embodiment, plural members belong to a workspace (for example, Company A). Example of the workspace includes a uniform resource locator (URL). Alternatively, any suitable information other than the URL may be used as the workspace, provided that the information is unique. Further, the workspace has plural channels according to the purposes of chat. The channel is a group of members among whom information to be shared is exchanged, such as a group for product A and a group for product B. One or more members of the members belonging to the workspace belong to the channel. In other words, the notification destination is identified by the workspace and the channel. Since the method of identifying the notification destination differs depending on the chat system, if there is identification information that can uniquely identify the group, that information alone may be used, or the notification destination may be identified by three or more pieces of information.

The channels are uniquely identified from one another. The member accounts 1 to n are accounts of members belonging to the channel. Each of these accounts is issued by the chat server 10. In the present embodiment, the bot is registered as a member for notifying other members belonging to the same group of information related to the reservation of the meeting room 6. In other words, the bot is a kind of a proxy of the meeting management server 30 or an imaginary member. Comment (text) by the bot is transmitted to the terminal device 60 of each of the member accounts 1 to n.

The workspace and channel are managed by the meeting management server 30. The workspace and channel are information for identifying the group to which the participant belongs.

The meeting management server 30 includes a communication unit 31, an information associating unit 32, a reservation information acquisition unit 33, a notification determination unit 34, a control information generation unit 35, a control information response unit 36, a meeting information notification unit 37, a usage management unit 38, a reservation information transmission unit 39, a task execution unit 40, and an information management unit 41. Each of these functional units included in the meeting management server 30 is a function implemented by operating any of the components illustrated in FIG. 3 by an instruction from the CPU 501 according to a program developed from the HD 504 to the RAM 503. The program is distributed from a server for program distribution or in a storage medium.

The communication unit 31 transmits and receives various kinds of information to and from the reservation management server 20, the chat server 10, and the terminal device 60. The communication unit 31 includes a transmission unit 31a and a reception unit 31b. The reception unit 31b receives reservation information from the reservation management server 20 and receives a request for reservation information from the meeting room terminal 90. Further, the reception unit 31b receives a check-in request from the meeting room terminal 90. Furthermore, the reception unit 31b receives, from the registration terminal 50 operated by the administrator, information indicating an association between the group of the chat system and the account. The transmission unit 31a transmits information related to the reservation of the meeting room to the chat server 10, and transmits the reservation information, a reminder, control information, and the like to the meeting room terminal 90.

The information associating unit 32 mainly performs processing relating to a preliminary registration process. Specifically, the information associating unit 32 receives a registration of a domain from the registration terminal 50 or the like and registers the domain with a customer domain DB 495. Further, the information associating unit 32 stores the workspace and the channel of the chat system transmitted from the registration terminal 50 or the like in association with the account of the reservation management server 20 in an association information DB 491.

The reservation information acquisition unit 33 obtains the reservation information from the reservation management server 20 by designating an account of a customer who uses the facility reservation system 100. The reservation information acquisition unit 33 registers the obtained reservation information as meeting management information with a meeting management information DB 493. Alternatively, the changed reservation information is automatically received. At least a part of the reservation information stored in the reservation management server 20 is stored in the meeting management information DB 493. More specifically, the reservation information acquisition unit 33 obtains the reservation information for a predetermined period in the future from the current time among the reservation information stored in the reservation management server 20. The predetermined period is determined depending on how long a period ahead is set to future meetings for which the information related to the reservation of the meeting room 6 is to be notified.

When the reservation information is acquired, the reservation information acquisition unit 33 generates an automatic cancellation task and registers the automatic cancellation task in the task queue 499. The task queue 499 is a first in first out (FIFO) queue, and is executed when execution time arrives. The automatic cancellation indicates that the facility reserved by the user is canceled without the user performing a cancel operation. For example, if the user does not perform an operation (check-in) to start using the facility by a fixed time, the reservation is automatically canceled.

The notification determination unit 34 determines whether the meeting management information includes a reservation whose start time satisfies a condition for notification. For example, the notification determination unit 34 refers to a notification settings DB 496 to determine whether the current time matches a date and time obtained by subtracting a preset period from the start time of the reservation. When the current time matches the obtained date and time by this subtraction, the notification determination unit 34 determines that a notification is to be sent. For example, when there are plural bots according to different roles, such as a bot for sending a reminder and a bot for receiving a reservation, the notification determination unit 34 determines a suitable bot according to processing to be performed.

When the notification determination unit 34 determines that the notification is to be sent, the meeting information notification unit 37 designate information identifying the bot (e.g., a token in SLACK) and information identifying the group as the notification destination, to request the chat server 10 to transmit a notification of the information related to the reservation of the meeting room 6. Note that the notification is performed several times, and the meeting identification information is included in at least one of the notifications. The meeting identification information is information based on which the meeting management server 30 confirms whether the participant has a right to use the reserved meeting room 6 during the reserved time slot. The meeting information notification unit 37 generates the meeting identification information by the final notification at the latest. The meeting identification information is registered in a meeting identification information DB 494.

The control information generation unit 35 refers to the meeting management information DB 493 to generate control information for the electronic device 70 and registers the generated control information in a control information DB 497. For example, the control information generation unit 35 generates control information for turning on the power of the electronic device 70 several minutes before the start time of the meeting. Further, the control information generation unit 35 generates control information for turning off the power of the electronic device 70 in response to detection of the check-out. The control information is stored in the control information DB 497.

In response to receiving an inquiry from the meeting room terminal 90 provided in the meeting room 6 as to whether there is control information, the control information response unit 36 refers to the control information DB 497 to transmit the control information corresponding to the meeting room 6 to the meeting room terminal 90.

The usage management unit 38 manages a check-in and a check-out to and from the meeting room. Further, the usage management unit 38 registers, in the meeting management information DB 493, a change in the status of meeting according to the check-in and the check-out. The check-in is allowed, for example, from 5 to 10 minutes before the start time of the meeting identified by the reservation ID. Further, the check-in is permitted when a pair of the meeting room ID and the meeting identification information transmitted from the meeting room terminal 90 is registered in the meeting identification information DB 494. When the usage management unit 38 permits check-in, the automatic cancellation task is deleted. Unless the automatic cancellation task is deleted, the task execution unit 40 cancels the reservation of the meeting room at a time, for example, 10 to 15 minutes after the start time of the meeting. In this case, the usage management unit 38 requests the reservation management server 20 to cancel the reservation. As a result, empty reservations can be reduced.

The reservation information transmission unit 39 transmits reservation information (the meeting management information, to be exact, but the reservation information is included) stored in the meeting management information DB 493 in response to a request from the meeting room terminal 90. The reservation information transmission unit 39 can transmit the reservation information in Java Script Object Notation (JSON) format, Extensible Markup Language (XML) format, Comma-Separated Values (CVS) format, or the like. Since the reservation information is repeatedly transmitted, a format having a smaller data size is preferable.

The task execution unit 40 periodically checks the tasks stored in the task queue 499 and executes the task whose execution time has arrived. Therefore, if the check-in request is not sent from the meeting room terminal 90 by a fixed timing based on the start time, the task execution unit 40 cancels the reservation of the meeting room (automatic cancellation) since the automatic cancellation task has not been deleted. Although the task described in this embodiment is the automatic cancellation task, various tasks that are executed at the time may be executed.

The information management unit 41 manages electronic data output while using a facility such as a meeting. For example, at the time of check-out, information for displaying electronic data is received from the meeting room terminal 90 and stored in the electronic data DB 492. At the time of check-in, information for displaying the electronic data identified based on the reservation information is acquired from the electronic data DB 492 and transmitted to the meeting room terminal 90. When the electronic data is stored in the electronic data DB 492, the information management unit 41 may convert the electronic data into a file format such as image data supported by the electronic device 70. If the information management unit 41 performs conversion at check-out, the time required to provide electronic data to the user at check-in can be shortened. However, the conversion may be done at check-in.

The meeting management server 30 further includes a storage unit 49. The storage unit 49 is implemented by the RAM 503, the HD 504, and the like of FIG. 3. The storage unit 49 includes the association information DB 491, the electronic data DB 492, the meeting management information DB 493, the meeting identification information DB 494, the customer domain DB 495, the notification settings DB 496, the control information DB 497, the meeting room setting information DB 498, and the task queue 499.

TABLE 3
Association Information DB

| | | Member | Member | Member | Member |
|---|---|---|---|---|---|
| Workspace | Channel | account 1 | account 2 | account 3 | account 4 |
| http://sample.com/1 | #marketing | a@xfood.com | b@xfood.com | c@xfood.com | d@xfood.com |
| | | a@chat.com | b@chat.com | c@chat.com | d@chat.com |
| http://sample.com/2 | #team1 | f@xfood.com | g@xfood.com | h@xfood.com | |
| | | f@chat.com | g@chat.com | h@chat.com | |
| . . . | . . . | . . . | . . . | . . . | . . . |

Table 3 is an example of association information stored in the association information DB 491. The association information is information associating the account of the reservation management system with the group of the chat system. The association information includes items of the workspace, the channel, and the member accounts 1 to n (n=4 in Table 3). The workspaces and channels are as described above. In the member accounts 1 to n, the accounts of participants issued by the reservation management server 20 are stored. The accounts of the chat system may be stored in the association information, as indicated in Table 3. To send a notification to the group, information identifying the account, issued by the reservation management server 20, of the user who made a reservation of a meeting to the reservation management server 20 and information (in the present embodiment, the workspace, and the channel name) identifying the group and channel of the notification destination will suffice. In other words, the accounts of all the members belonging to the group are not necessarily stored in the association information. However, the account information of the chat system of each individual user is required when sending a notification to the individual user. Accordingly, the account of the user of the chat system can also be stored in the association information, as indicated in Table 3.

TABLE 4
Electronic Data DB

| Reservation | Meeting | Electronic | Displayed |
|---|---|---|---|
| ID | room ID | data | device |
| 001 | K-001 | whiteboard.pdf | electronic |
| | | sample.doc | whiteboard |
| 002 | K-001 | abc.pdf | projector |
| | | xyz.jpeg | |
| . . . | . . . | . . . | . . . |

Table 4 is an example of an electronic data table stored in the electronic data DB 492 of the meeting management server 30. The meeting room ID and electronic data are stored in the electronic data DB 492 in association with the reservation ID. The item of the electronic data may be the electronic data itself, or may be a path, a URL, or the like for identifying electronic files. The place where the electronic data is stored is not limited to the meeting management server 30, and may be an external server or the meeting room.

The electronic data is electronic data used in the past meetings. Since the electronic data is associated with the reservation ID, the electronic data is also associated with the reservation information of the meeting management information DB 493. The electronic device 70 that outputs the electronic data is registered as an item of displayed device. For example, in the case of handwritten data, the displayed device is the electronic device 70 or the terminal device 60, in the case of voice data by utterance, the displayed device is the electronic device 70 or the terminal device 60 that collects sound as voice data, in the case of a browsed file or a web page, the displayed device is the electronic device 70 or the terminal device 60, and in the case of the minutes of the meeting, the displayed device is the electronic device 70 that created the minutes of the meeting. The electronic device 70 that outputs the electronic data is identified by, for example, an internet protocol (IP) address, a media access control (MAC) address, an email address, or the like. As a result, the electronic device 70 that has displayed the electronic data in the past can display the same electronic data again.

TABLE 5
Meeting Management Information DB

| | Account of | | | | | Account of | |
|---|---|---|---|---|---|---|---|
| Reservation | reservation-making | Meeting | Meeting | Start | End | expected | |
| ID | user | name | room ID | time | time | participant | Status |
| 001 | a@xfood.com | Product Z | K-001 | July 7, 2017 | July 7, 2017 | b@xfood.com | Checked |
| | | development | | 10:00 | 12:00 | c@xfood.com | in |
| | | meeting | | | | d@xfood.com | |
| 002 | e@xfood.com | Product Y | K-001 | July 7, 2017 | July 7, 2017 | f@xfood.com | Reservation |
| | | development | | 13:00 | 14:00 | g@xfood.com | information |
| | | meeting | | | | | Notified |
| . . . | . . . | . . . | . . . | . . . | . . . | . . . | . . . |

Table 5 is an example of meeting management information stored in the meeting management information DB 493 of the meeting management server 30. Since the reservation information is stored in the meeting management information DB 493, the difference from the reservation information DB 291 in Table 1 is described in Table 5. The meeting management information in Table 5 includes “status” as an item. The status indicates status of a reservation. For example, the status such as information related to the reservation of the meeting room 6 notified, reservation confirmed, waiting for check-in, checked-in, checked-out, or cancellation is stored.

TABLE 6
Meeting Identification Information DB

| Reservation ID | Meeting room ID | Meeting identification information |
|---|---|---|
| 001 | K-001 | 1234 |
| 002 | K-002 | 5678 |
| . . . | . . . | . . . |

Table 6 is an example of meeting identification information management information stored in the meeting identification information DB 494. The meeting identification information management information is information for managing the meeting identification information for each reservation of the meeting room 6. The meeting identification information management information includes items of the reservation ID, the meeting room ID, and the meeting identification information. The reservation ID, the meeting room ID, and the meeting identification information of the meeting identification information management information in Table 6 are the same or substantially the same as those of the reservation information (the reservation information acquired from the reservation management server 20) except for the status. Accordingly, the redundant descriptions thereof are omitted. Note that the reservation ID is stored in order to identify the reservation of the same meeting room 6. The status indicates status of a reservation. For example, the status stored in the reservation information of Table 4 indicates whether a notification of the information about the reservation of the meeting room has been sent, whether the use of the meeting room has been confirmed, whether the check-in operation has been performed, whether the check-out operation has been performed, or whether the reservation has been cancelled.

TABLE 7
Customer Domain DB

| Customer's domain name | Customer's administrator account |
|---|---|
| xfood.com | a@xfood.com |
| ycar.com | f@ycar.com |
| . . . | . . . |

Table 7 is an example of customer domain information stored in the customer domain DB 495. The customer domain information is information for managing a customer's domain name and an account of an administrator of the customer. The customer domain information stores the domain name of the customer with the administrator's account. The domain name of the customer in Table 7 is the domain name of the account (email address) issued by the reservation management server 20. The administrator's account is the account of the administrator (representative) of the customer. The reservation management server 20 issues the accounts in Table 7.

TABLE 8
Notification Settings DB

| Customer's domain name | Notification settings |
|---|---|
| xfood.com | One day before |
| ycar.com | 12 hours before |
| . . . | . . . |

Table 8 is an example of notification setting information stored in the notification setting DB 496. The notification setting information includes, for each of the customers, settings relating to a notification. The notification setting information stores the domain name of the customer in association with notification settings. The notification settings indicates a timing at which the information related to the reservation of the meeting room 6 is to be notified. In Table 8, the notification settings define how long ahead the start time of the meeting the notification of the information related to the reservation of the meeting room is to be sent. In another example, a fixed date and time may be set in the notification settings. Further, the number of the timings set in the notification settings is not necessarily one. A plurality of notification settings may be stored in association with one customer.

TABLE 9
Control Information DB

| Meeting room ID | Control content |
|---|---|
| K-001 | Turn on |
| K-002 | Turn off |
| . . . | . . . |

Table 9 is an example of control information stored in the control information DB497. The control information is information for controlling the electronic device 70 provided in the meeting room 6. The control information includes the meeting room ID and a control content. The control content indicates a specific control operation of the electronic device 70. The meeting management server 30 can set adetailed control content for each electronic device 70. The control information does not include information indicating atime at which the electronic device 70 is to be controlled. This is because it is difficult for the meeting management server 30 to access the meeting room terminal 90 since the meeting management server 30 resides on the external network N2. Accordingly, the meeting management server 30 transmits the control content when the control information has already been generated and when being accessed from the meeting room terminal 90.

TABLE 10
Meeting Room Setting Information DB

| Meeting room | Meeting | Status of meeting | Authentication | Management | |
|---|---|---|---|---|---|
| name | room ID | room terminal | key | start flag | Access time |
| Meeting room A | K-001 | Connected | ***** | True | Oct. 15, 20XX |
| | | | | | 12:34 |
| Meeting room B | K-002 | Connected | ***** | False | Oct. 15, 20XX |
| | | | | | 12:48 |
| Meeting room C | K-003 | Disconnected | ***** | True | Oct. 15, 20XX |
| | | | | | 12:50 |

Table 10 is an example of the meeting room setting information stored in the meeting room setting information DB498. The meeting room setting information is information relating to settings of each meeting room. The meeting room setting information includes items of the meeting room name, the meeting room ID, status of the meeting room terminal, the authentication key, a management start flag, and access time. The meeting room name is a general-purpose name of a meeting room recognized by participants attending in the meeting. Examples of the meeting room name include a name that is presented at the entrance of the meeting room. The meeting room ID is identification information for uniquely identifying a meeting room, as described above. In one example, the meeting room ID is common to the meeting room setting information and the reservation management server 20, to simplify the configuration and operation. In another example, a conversion table is provided that allows the administrator to set the different meeting room ID from the meeting room ID stored in the reservation management server 20. The status of the meeting room terminal indicates whether the configuration of initial settings of the meeting room terminal 90 has been completed, whether communication is possible, and the like, as described in the following.

Connected: For example, communication is confirmed by polling.

Before setup: Before initial settings are made.

Disconnected: No communication for a certain period of time (M minutes in the present embodiment).

The authentication key is authentication information used by the meeting management server 30 to authenticate the meeting room terminal 90. The authentication key is transmitted to the meeting room terminal 90 by the initial settings. The authentication key is a combination of numbers, alphabets, symbols, and the like that are too long to be identified by brute force attack. In one example, the meeting management server 30 determines the authentication key. In another example, the administrator determines the authentication key. The management start flag is a flag indicating whether the meeting management server 30 starts managing the meeting room after the initial settings of the meeting room terminal 90 has been configured. The value “true” set in the management start flag indicates that the meeting management server 30 starts managing the meeting room. The value “false” set in the management start flag indicates that the meeting management server 30 does not start managing the meeting room. The management start flag substantially eliminates inconveniences caused by a time lag between the time when the configuration of the initial settings is completed and the time when the meeting room terminal 90 is arranged in the meeting room. The access time is a time when the reservation information periodically requested by the meeting room terminal 90 is recorded every N minutes. The recording of access time is not limited to in response to the request for reservation information, and the time of communication with the meeting room terminal 90 may be recorded.

TABLE 11
Task Queue

| Task ID | Execution time | Task content | Reservation ID |
|---|---|---|---|
| T-001 | Oct. 17, 20XX | Automatic cancellation | 002 |
| | 10:10 | | |
| T-002 | Oct. 17, 20XX | Automatic cancellation | 003 |
| | 13:10 | | |

Table 11 is an example of tasks stored in the task queue 499. The tasks to be executed by the meeting management server 30 are stored in the task queue 499 in a chronological order. The task queue 499 includes items of a task ID, execution time, task content, and the reservation ID. The task ID is identification information for identifying the task. The execution time is time when a task is to be executed. The task content is the specific content of a task. The reservation ID is set to identify the reservation information of the meeting management information DB 493. For example, when a reservation of the meeting room is canceled, the task execution unit 40 identifies the reservation information of the meeting management information DB 493 and changes the status to “cancelled”.

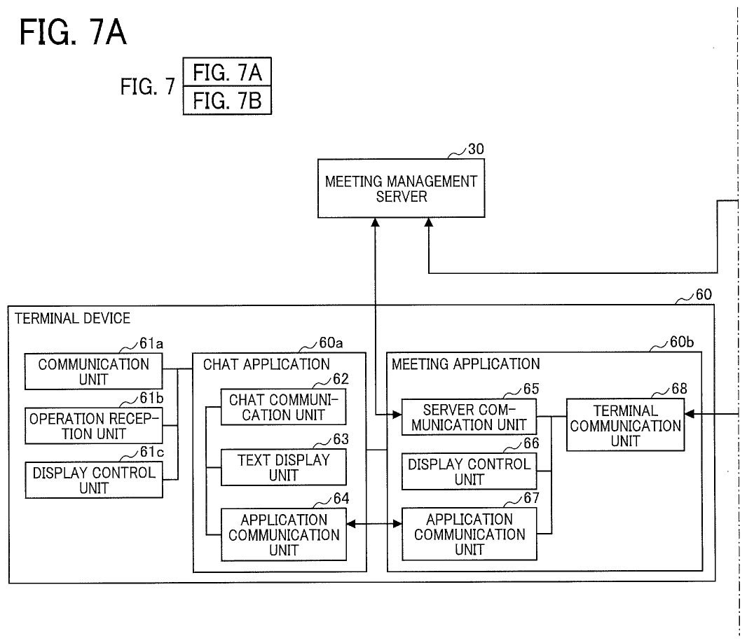

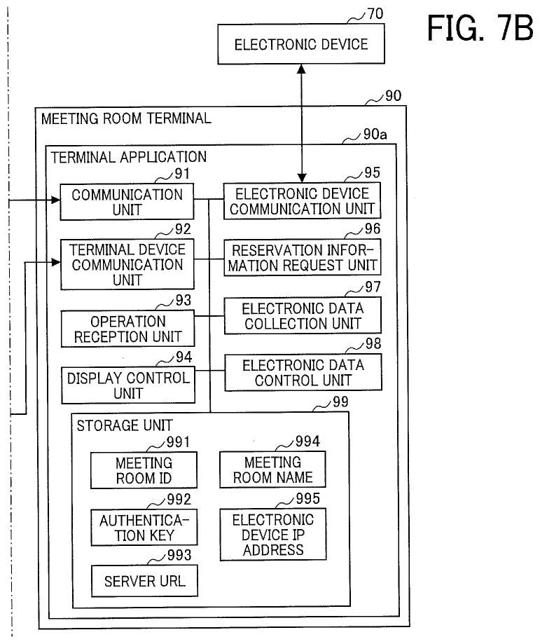

FIGS. 7A and 7B are block diagrams illustrating examples of functional configurations of the terminal device 60 and the meeting room terminal 90. The functions of the registration terminal 50 and the electronic device 70 is described as necessary.

The terminal device 60 includes a communication unit 61a, an operation reception unit 61b, a display control unit 61c, a chat communication unit 62, a text display unit 63, an application communication unit 64, a server communication unit 65, a display control unit 66, an application communication unit 67, and a terminal communication unit 68. Each of these functional units included in the terminal device 60 is a function implemented by operating any of the components illustrated in FIG. 3 by an instruction from the CPU 501 according to a program developed from the HD 504 to the RAM 503. The program is distributed from a server for program distribution or in a storage medium. Since the chat application 60a and the meeting application 60b operate on the terminal device 60, the program includes the chat application 60a and the meeting application 60b.

The communication unit 61a transmits and receives various types of information to and from the meeting management server 30 and the reservation management server 20. The operation reception unit 61b receives various operations that are input by the participant to the terminal device 60.

The display control unit 61c interprets screen information of various screens to display screens on the display 506. The operation reception unit 61b and the display control unit 61c includes, for example, a browser function and executes a web application. For example, the display control unit 61c displays a reservation setting screen received from the reservation management server 20, and the operation reception unit 61b receives reservation information set by a reservation-making user.

The chat communication unit 62 of the chat application 60a transmits and receives various types of information to and from the chat server 10. In the present embodiment, the chat communication unit 62 receives information related to the reservation of the meeting room 6 from the chat server 10. Further, the chat communication unit 62 sends, to the chat server 10, a notification indicating that a message of the information about the reservation of the meeting room 6 has been read and a notification indicating whether the meeting room 6 is to be used or canceled.

The text display unit 63 of the chat application 60a displays text (the information related to the reservation of the meeting room 6) transmitted from the chat server 10. For example, the text display unit 63 displays the text as if the source of the message is the bot and as if the bot inputs the text.

The application communication unit 64 of the chat application 60a invokes the meeting application 60b and transmits the meeting identification information to the meeting application 60b. The chat server 10 transmits information identifying the meeting application 60b to the terminal device 60, when notifying the terminal device 60 of the information about the reservation of the meeting room 6. Accordingly, the chat application 60a designates the meeting application 60b to the OS and requests notification of the meeting identification information. The OS activates the meeting application 60b.

The server communication unit 65 of the meeting application 60b communicates with the meeting management server 30. For example, the server communication unit 65 obtains a two-dimensional code including the meeting identification information from the meeting management server 30. The two-dimensional code is used for authentication at check-in. Instead of or in addition to the two-dimensional code, numbers of a several digits can be used for authentication.

The display control unit 66 of the meeting application 60b displays the two-dimensional code or the like including meeting identification information on the display 506.

The application communication unit 67 of the meeting application 60b obtains various kinds of information from the chat application 60a through the OS. Examples of the various kinds of information obtained from the chat application 60a include the meeting identification information included in the information related to the reservation of the meeting room 6.

The terminal communication unit 68 communicates with the meeting room terminal 90 to transmit the meeting identification information, and the like. The terminal communication unit 68 detects the meeting room terminal 90 using a short-range wireless communication network such as BLUETOOTH (registered trademark). In response to detecting the meeting room terminal 90, the terminal communication unit 68 transmits the meeting identification information to the detected meeting room terminal 90. Further, the terminal communication unit 68 provides a function of displaying the two-dimensional code (when checking in with the two-dimensional code) to the meeting room terminal 90.

The meeting room terminal 90 includes a communication unit 91, a terminal device communication unit 92, an operation reception unit 93, a display control unit 94, an electronic device communication unit 95, a reservation information request unit 96, an electronic data collection unit 97, and an electronic data control unit 98. Each of these functional units included in the meeting room terminal 90 is a function implemented by operating any of the components illustrated in FIG. 4 by an instruction from the CPU 701 according to a program developed from the EEPROM 704 to the RAM 703. The program is distributed from a server for program distribution or in a storage medium.

The communication unit 91 communicates with the meeting management server 30 with a server URL 993 as a destination. Since the meeting room terminal 90 resides on the intra-company network N1, accessing from the meeting management server 30 to the meeting room terminal 90 is difficult. For this reason, the communication unit 91 polls the meeting management server 30 to periodically communicate with the meeting management server 30. In addition to or in alternative to the polling, the communication unit 91 communicates with the meeting management server 30 using a communication technology such as webSocket. When there is no communication from the communication unit 91, “disconnected” is registered in the meeting room setting information DB 498. The communication unit 91 may communicate using a communication protocol such as Hypertext Transfer Protocol (HTTP), and the communication protocol is not particularly limited.

The communication unit 91 according to the present embodiment, transmits to the meeting management server 30, the meeting identification information which is received by the terminal device communication unit 92 from the terminal device 60 or is manually input at check-in. When the use of the meeting room is permitted, the communication unit 91 receives information for displaying the electronic data from the meeting management server 30. In addition, the communication unit 91 transmits information for displaying the electronic data to the meeting management server 30 in response to the check-out of the meeting room (operation to end the use). Further, the communication unit 91 receives the control information from the meeting management server 30.

The terminal device communication unit 92 communicates with the terminal device 60 by the short-range wireless communication such as BLUETOOTH (registered trademark) and NFC. In the present embodiment, the terminal device communication unit 92 receives the meeting identification information, and the like.

The electronic device communication unit 95 communicates with the electronic device 70. In the present embodiment, the electronic device communication unit 95 transmits, to the electronic device 70, the control information received by the communication unit 91. In addition, the electronic data is acquired from the electronic device 70 at check-out, and the electronic data is transmitted at check-in. However, the electronic data itself is not always transmitted and received, and information for displaying the electronic data may be transmitted and received. For example, Wi-Fi may be used for communication. BLUETOOTH (registered trademark) or the like, which consumes less power, may be used. In this case, short-range wireless communication such as BLUETOOTH (registered trademark) is used for the electronic device 70 to accept the power on, and Wi-Fi (access point) becomes effective after activation, so the electronic data can be transmitted and received using Wi-Fi. BLUETOOTH (registered trademark) may be paired in advance, or if pairing is not required, the electronic device communication unit 95 may search for a device in a short distance at the time of execution.

The display control unit 94 displays a screen generated by the terminal application 90a on the display 718. The screen displayed by the display control unit 94 is a reservation status screen that receives the check-in and the check-out. The operation reception unit 93 receives various operations input to the meeting room terminal 90.

The reservation information request unit 96 repeatedly transmits the meeting room ID 991 and the authentication key 992 to the meeting management server 30 through the server communication unit 91 at a periodic time interval for acquiring the reservation information. As a response to the transmission of the meeting room ID 991 and the authentication key 992, the reservation information request unit 96 acquires the reservation information through the communication unit 91. It is sufficient that the reservation information be acquired when any change is made in the reservation information. Examples of the periodical time interval for the reservation information request unit 96 to acquire the reservation information include from every several seconds to every several minutes. The shorter the periodical time interval, the sooner the reservation information is updated. However, the shorter the periodical time interval, communication load is greater. Accordingly, the periodical time interval is determined in view of both the update frequency of the reservation information and the communication load. In the present embodiment, the reservation information request unit 96 acquires the reservation information every thirty seconds, for example. Further, the reservation information request unit 96 receives at least the meeting management information (reservation information) of the meeting room 6 of the current day through the communication unit 91.

At check-out, the electronic data collection unit 97 requests the electronic device 70 to transmit information for displaying the electronic data. The electronic data control unit 98 transmits information for displaying the electronic data collected by the electronic data collection unit 97 to the meeting management server 30. Further, the electronic data control unit 98 notifies the meeting management server 30 of the check-in request at the time of check-in, and transmits information for displaying the electronic data received from the meeting management server 30 to the electronic device 70. The check-in request may include request information for displaying the electronic data.

The reason for the electronic data control unit 98 to start receiving electronic data after check-in is to prevent another person from seeing the electronic data by confirming that the person who made the reservation is the person receiving the electronic data. If the use of the facility is permitted, the user who uses the meeting room is found to be the user who has registered the reservation information. Therefore, it is presumed that the user who checked in has the authority to view the electronic data corresponding to the past reservation information identified based on the reservation information regarding check-in.

The meeting room terminal 90 further includes a storage unit 99. The storage unit 99 is implemented by the ROM 702, the EEPROM 704, and the like of FIG. 4. The storage unit 99 stores the meeting room ID 991, the authentication key 992, the server URL 993, the meeting room name 994, and the IP address 995 of the electronic device 70. The meeting room ID 991, the authentication key 992, the server URL 993, and the meeting room name 994 are stored by the initial settings of the meeting room terminal 90. The meeting room terminal 90 communicates with the meeting management server 30 to acquire reservation information by using the meeting room ID 991, the authentication key 992, and the server URL 993.

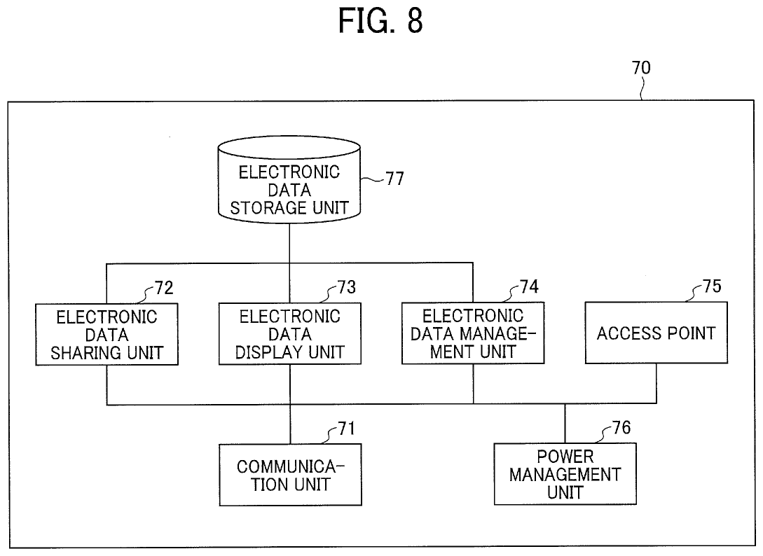

FIG. 8 is a block diagram illustrating a functional configuration of the electronic device 70. The electronic device 70 includes a communication unit 71, an electronic data sharing unit 72, an electronic data display unit 73, an electronic data management unit 74, an access point 75, and a power management unit 76. Each of these functional units included in the electronic device 70 is a function implemented by operating any of the components illustrated in FIG. 5 by an instruction from the CPU 201 according to a program developed from the SSD 204 to the RAM 203.

The communication unit 71 communicates with the meeting room terminal 90 wirelessly or by wire. Even if the power of the electronic device 70 is turned off before the check-in, the communication unit 71 is in a sleep state and check-in notifications and control information from the meeting room terminal 90 are received. When the communication unit 71 receives the check-in notification from the meeting room terminal 90, the power management unit 76 activates the electronic device 70.

Upon activation, the access point 75 operates, randomly generates a service set identifier (SSID) and an encryption key, and constructs a local wireless network. As a result, the terminal device 60 is connected to the access point 75. The access point 75 displays connection information to the network (SSID and encryption key) on the display 280. This information may be passed to the meeting room terminal 90 for display.

The electronic data sharing unit 72 includes a file sharing function such as a File Transfer Protocol (FTP) server and starts sharing electronic data. When the communication unit 71 receives information for displaying the electronic data from the meeting room terminal 90 at check-in, the electronic data sharing unit 72 acquires the electronic data with the information for displaying the electronic data and stores the electronic data in the electronic data storage unit 77.

The electronic data management unit 74 manages the electronic data stored in the electronic data storage unit 77. For example, at the time of check-in, predetermined electronic data (the oldest creation time, the first page, the last page, etc.) is acquired and displayed on the electronic data display unit 73.

The electronic data display unit 73 displays the electronic data stored in the electronic data storage unit 77 on the display. In addition, the electronic data display unit 73 also displays a URL for the guest terminal (terminal device 60) to access the electronic data on the display. This information may also be transmitted to the meeting room terminal 90 for display. The terminal device 60 may be connected to the access point 75 to transmit electronic data to the electronic device 70.

During the meeting, the electronic data management unit 74 stores the electronic data transmitted from the terminal device 60 in the electronic data storage unit 77 in association with the reservation ID. This reservation ID is for the reservation information of the meeting room checked in by the user. When the electronic data transmitted from the meeting room terminal 90 at the time of check-in is stored in the electronic data storage unit 77, the electronic data transmitted from the terminal device 60 may be added, or may be stored separately. When the electronic data transmitted from the terminal device 60 is stored separately, the electronic data is distinguished by the reservation ID.

When the communication unit 71 receives the check-out notification from the meeting room terminal 90, the electronic data management unit 74 generates information for displaying the electronic data of the current day or all electronic data including the past from the electronic data storage unit 77, and transmits to the communication unit 71. The communication unit 71 transmits information for displaying the electronic data to the meeting room terminal 90. The electronic data management unit 74 stores the electronic data based on the information for displaying the electronic data, and deletes the electronic data of the electronic data storage unit 77. Then, the power management unit 76 puts the electronic device 70 into the sleep state.

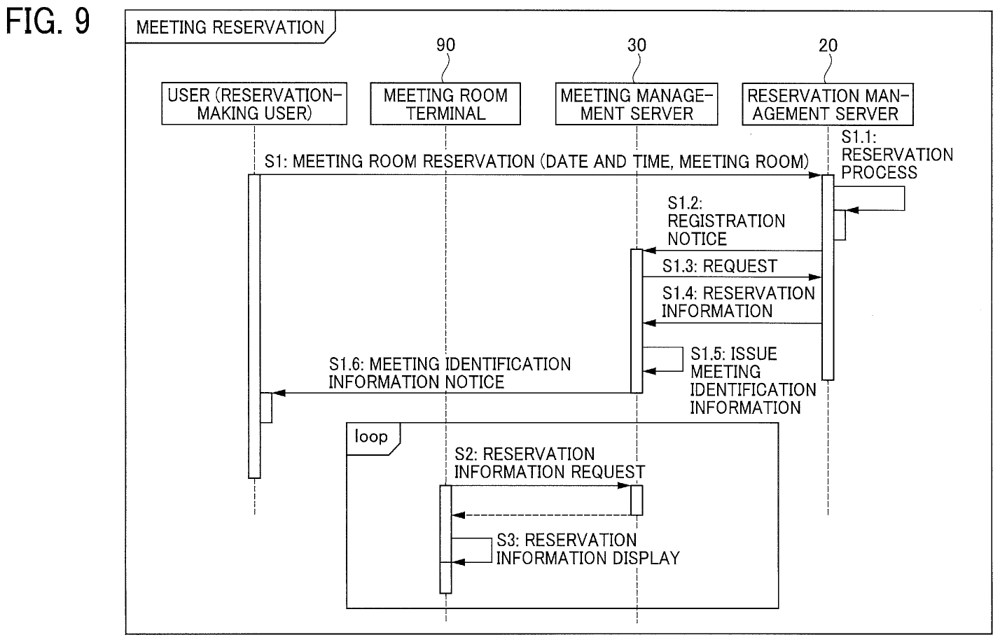

A process for displaying the reservation status screen by the meeting room terminal 90 is described with reference to FIG. 9. FIG. 9 is a sequence diagram illustrating an example from reservation of a meeting room to display of a reservation status screen.

In step S1, the reservation-making user operates the terminal device 60 to connect to the reservation management server 20 and receives authentication from the reservation management server 20. If the authentication is successful, the meeting room is reserved by setting the meeting start time, end time, meeting room, meeting name, etc. on a particular web page or a dedicated application. The communication unit 61a of the terminal device 60 transmits these reservation information to the reservation management server 20.

In step S1.1, The communication unit 21 of the reservation management server 20 receives the reservation information, and the reservation information management unit 22 registers the reservation information in the reservation information DB 291. The reservation information will be a part of the schedule for each meeting room. The reservation information is also reflected in the individual schedule of the reservation-making user.

In step S1.2, the communication unit 21 of the reservation management server 20 notifies the meeting management server 30 of the change in the reservation information together with the domain of the reservation-making user.

In step S1.3, the reservation information acquisition unit 33 of the meeting management server 30 requests the reservation information by designating the domain that identifies the customer from the reservation management server 20 periodically or in response to the notification from the reservation management server 20. The license information of the meeting management server 30 is also included for authentication.

In step S1.4, the communication unit 21 of the reservation management server 20 receives the request and transmits the reservation information of the reservation-making user having the designated domain acquired from the reservation information DB 291 by the reservation information management unit 22 to the meeting management server 30.

In step S1.5, the reservation information acquisition unit 33 of the meeting management server 30 acquires the reservation information and stores the reservation information in the meeting management information DB 493. The reservation information acquisition unit 33 issues meeting identification information for each acquired reservation information and stores the meeting identification information in the meeting identification information DB 494.

In step S1.6, the meeting information notification unit 37 of the meeting management server 30 detects a reservation-making user or a participant from the association information DB 491, identifies the information that identifies the group on the chat server 10, and notifies the chat server 10 of the completion of the reservation (including the meeting identification information). As a result, the text processing unit 12 of the chat server 10 broadcasts the reservation information such as the meeting identification information to the group (workspace channel) identified by the information that identifies the group. The notification may be sent by email. The reservation-making user or the participant inputs the meeting identification information as necessary at the time of check-in to the meeting room terminal 90.

In step S2, the reservation information request unit 96 of the meeting room terminal 90 designates the authentication key 992 and the meeting room ID 991 and requests the reservation information from the meeting management server 30 to the server URL 993 periodically or in response to the operation of the participants. (When the meeting room terminal 90 is common to a plurality of meeting rooms, a plurality of authentication keys 992 and the meeting room ID 991 are transmitted). When the reception unit 31b of the meeting management server 30 receives the request and the pair of the authentication key and the meeting room ID is stored in the meeting room setting information DB 498, the reservation information (information in the meeting management information DB) identified by the meeting room ID is acquired from the meeting management information DB 493 and transmitted to the meeting room terminal 90.

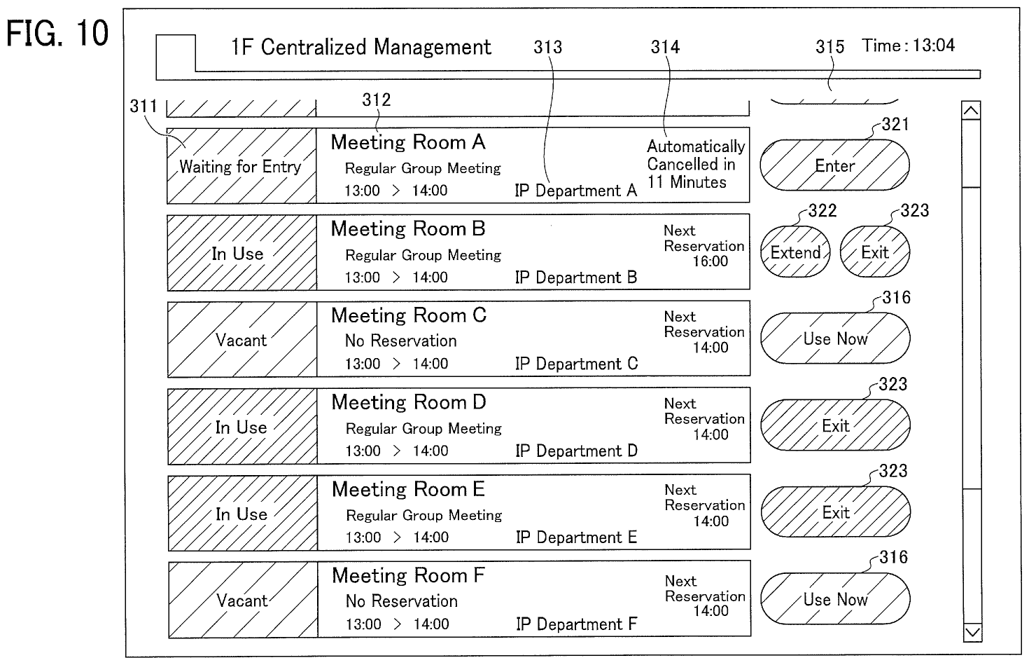

In step S3, the communication unit 91 of the meeting room terminal 90 receives the reservation information, and the display control unit 94 displays the reservation information on the reservation status screen. An example of the reservation status screen is illustrated in FIG. 10.

An example of a screen operated by the user at the time of check-in or check-out is described with reference to FIG. 10. FIG. 10 is a diagram illustrating an example of the reservation status screen displayed by the meeting room terminal 90. The reservation status screen of FIG. 10 is a reservation status screen displayed by the meeting room terminal 90 common to a plurality of meeting rooms.

The reservation status screen 300 of FIG. 10 includes items of usage status 311, detailed information 312, reservation-making user name 313, message 314, and button column 315. The usage status 311 indicates the current usage status of the meeting room based on the status of the reservation information. For example, waiting for entry (waiting for check-in), in use (checked-in), or vacancy is displayed. The detailed information 312 indicates the meeting room name, meeting name, start time and end time. Both are included in the reservation information managed by the meeting management server 30. The reservation-making user name 313 indicates the name of the reservation-making user. The reservation-making user name is included in the reservation information managed by the meeting management server 30. The message 314 indicates the remaining time until automatic cancellation and the start time of the next reservation. These information are transmitted from the meeting management server 30. The button column 315 includes a use now button 316, an entry button 321 and an extension button 322, and an exit button 323. Each button is displayed depending on the situation. The use now button 316 is a button for the user to reserve the meeting room immediately (the meeting management server 30 reserves the meeting room on the reservation management server 20 with the license of the meeting management server 30, and the user will be able to check-in from the meeting room terminal 90). The use now button 316 is displayed when the meeting room is vacant. The entry button 321 is displayed when the usage status is waiting for check-in (an example of a display component that accepts the start of use). The entry corresponds to check-in. The extension button 322 and the exit button 323 are displayed when the usage status is in use. The extension button 322 and the exit button 323 are for the reservation-making user who has already checked-in to extend the meeting or to check-out. However, if extension is not possible (if the next meeting is reserved), the extension button will not be displayed. The exit corresponds to check-out.

In FIG. 10, the reservation status screen indicating a plurality of meeting rooms has been described so that all the buttons are illustrated in one diagram. However, when the meeting room terminal 90 is dedicated to a meeting room, only the reservation status of the meeting room is displayed.

The reservation status screen 300 is displayed using the reservation information received from the meeting management server 30 by the terminal application 90a of the meeting room terminal 90. Alternatively, the reservation status screen 300 may be displayed by operating the web browser on the meeting room terminal 90 and displaying the web page transmitted from the meeting management server 30 by the web browser.

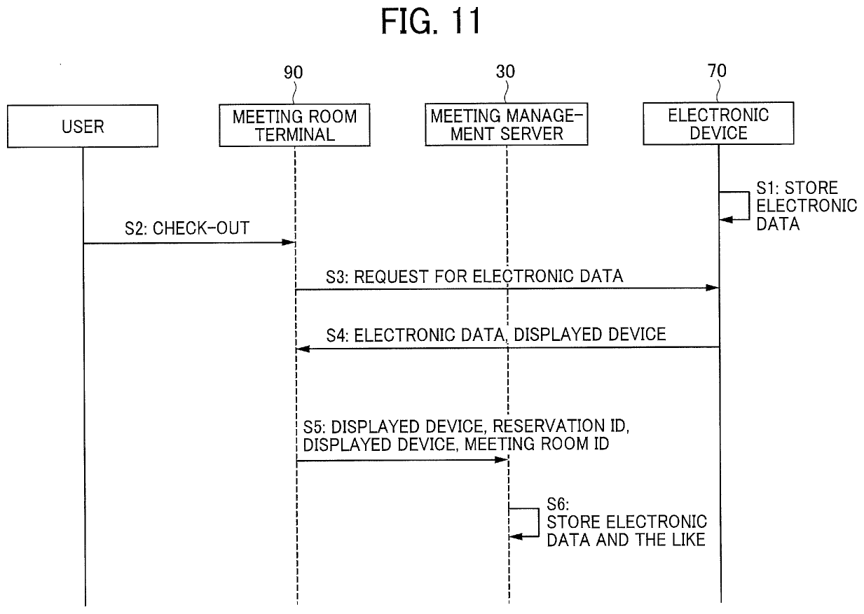

FIG. 11 is a sequence diagram illustrating an example of an operation or process performed by the facility reservation system 100 when a user checks out.

In step S1 in FIG. 11, the meeting has already started. The check-in process for starting the meeting is described below. During the meeting, the electronic data management unit 74 of the electronic device 70 stores data handwritten on display 280 (character recognition may be performed), electronic data transmitted from the terminal device 60, voice data (may be voice recognized), information acquired from the internet, and automatically created summaries and minutes in the electronic data storage unit 77. These are the data used during the meeting.

In step S2, the user presses the exit button 323 associated with the meeting room in which the user is having a meeting on the reservation status screen 300 to check-out. The operation reception unit 93 of the meeting room terminal 90 receives the press. In order to allow the check-out after the meeting management server 30 confirms that the meeting room was used by the user, the input of the meeting identification information may be received.

In step S3, the electronic data collection unit 97 of the meeting room terminal 90 requests the electronic device 70 through the electronic device communication unit 95 to provide information for displaying the electronic data used during the meeting. The electronic data used during the meeting is all the electronic data stored in the electronic data storage unit 77 of the electronic device 70. When the electronic data storage unit 77 also stores the electronic data of the past meeting, only the information for displaying the electronic data of the meeting of the current day is sufficient. As a result, communication load and pressure on storage capacity of the meeting management server 30 can be reduced.

The electronic data management unit 74 of the electronic device 70 may transmit information (mainly electronic data) for displaying the electronic data to the meeting management server 30 without waiting for the check-out. In this case, the electronic data management unit 74 can transmit electronic data when the access point 75 receives a new file, at regular intervals, at the timing designated by the user, or when the communication load is small.

In step S4, the communication unit 71 of the electronic device 70 receives a request for information for displaying the electronic data. When the electronic device 70 transmits the electronic data itselft, the electronic data management unit 74 acquires only the electronic data of the current day from the electronic data storage unit 77. The communication unit 71 transmits the electronic data to the meeting room terminal 90. When sending the electronic data, the electronic data should be in a file format. The electronic data management unit 74 may acquire all the electronic data including the electronic data of the past meetings, and the communication unit 71 may transmit the electronic data to the meeting room terminal 90. As a result, the user can view all the electronic data of the past meetings as well as the latest meeting by check-in. Further, the electronic device 70 transmits information related to the displayed device such as the IP address to the meeting room terminal 90.

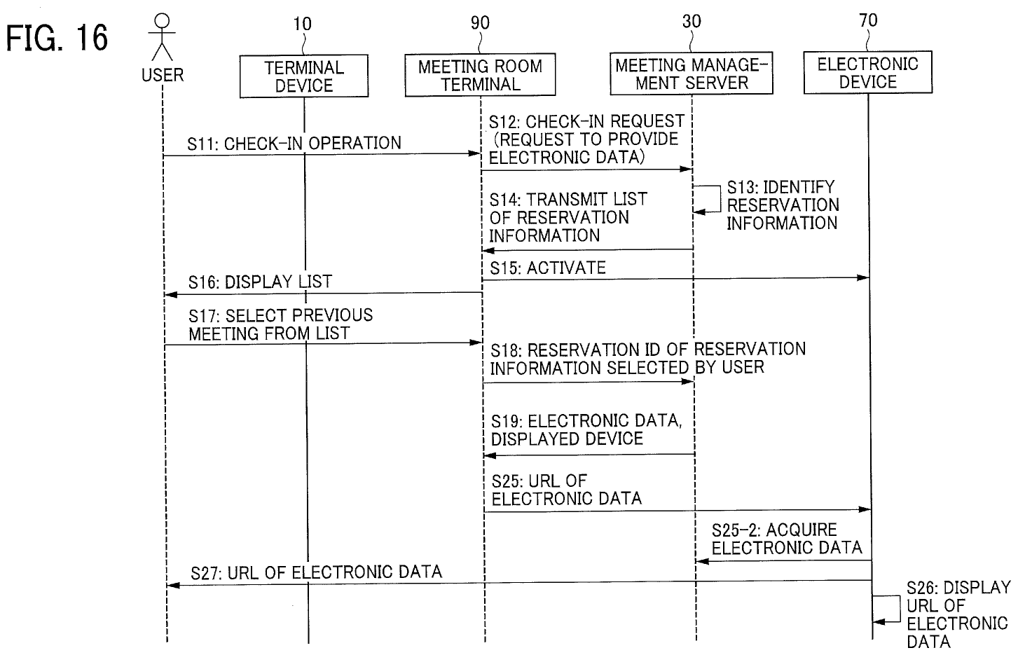

When the electronic device 70 transmits information for displaying the electronic data, the electronic device 70 keeps the electronic data stored or registers the electronic data in a file server. The electronic device 70 transmits a URL (information for displaying electronic data) indicating a storage location to the meeting room terminal 90. In this case, the URL of the electronic data storage destination is registered in Table 4. As a result, the communication load required for transmitting and receiving the electronic data can be reduced. As described with reference to FIG. 16, the meeting management server 30 can notify the electronic device 70 of the storage location of the electronic data by a URL.

In step S5, the electronic data collection unit 97 of the meeting room terminal 90 receives the information for displaying the electronic data and the information related to the displayed device through the electronic device communication unit 95, and the communication unit 91 transmits information for displaying the electronic data, information related to the displayed device, a reservation ID, and a meeting room ID to the meeting management server 30. The reservation ID is identification information of the reservation information of the meeting room held at the time of check-out. The meeting room ID is identification information of the meeting room.

The communication unit 91 also notifies the meeting management server 30 of the check-out. As a result, the usage management unit 38 changes the status of the meeting management information DB 493 identified by the reservation ID to “checked out”. Since the reservation information including the status is transmitted to the meeting room terminal 90, the meeting room terminal 90 updates the reservation status screen 300. If the start time of the next meeting is within 5 to 10 minutes, the entry button is displayed, and if the next meeting, is not scheduled, the use now button is displayed immediately.

In step S6, the reception unit 31b of the meeting management server 30 receives the information for displaying the electronic data, the information related to the displayed device, the reservation ID, and the meeting room ID, and the information management unit 41 stores the information for displaying the electronic data, the information related to the displayed device, the reservation ID, and the meeting room ID in the electronic data DB 492.

The electronic data collection unit 97 of the meeting room terminal 90 may acquire electronic data not only from the electronic device 70 but also from the terminal device 60 brought in by the participants. For example, the terminal device 60 and the meeting room terminal 90 communicate with each other to directly receive the electronic data. The material (information for displaying the electronic data) uploaded by the terminal device 60 to the URL displayed by the electronic device 70 has already been transmitted from the electronic device 70 to the meeting room terminal 90.

Further, in FIG. 11, the user ends the use of the meeting room by the check-out operation, and the collection of information for displaying the electronic data is started. Alternatively, the collection of information for displaying the electronic data may be started when the end time of the meeting elapses, lighting of the meeting room is turned off, the power of the electronic device 70 is turned off, and the like.

Further, information for displaying electronic data may be delivered to the terminal device 60 at the time of the check-out.

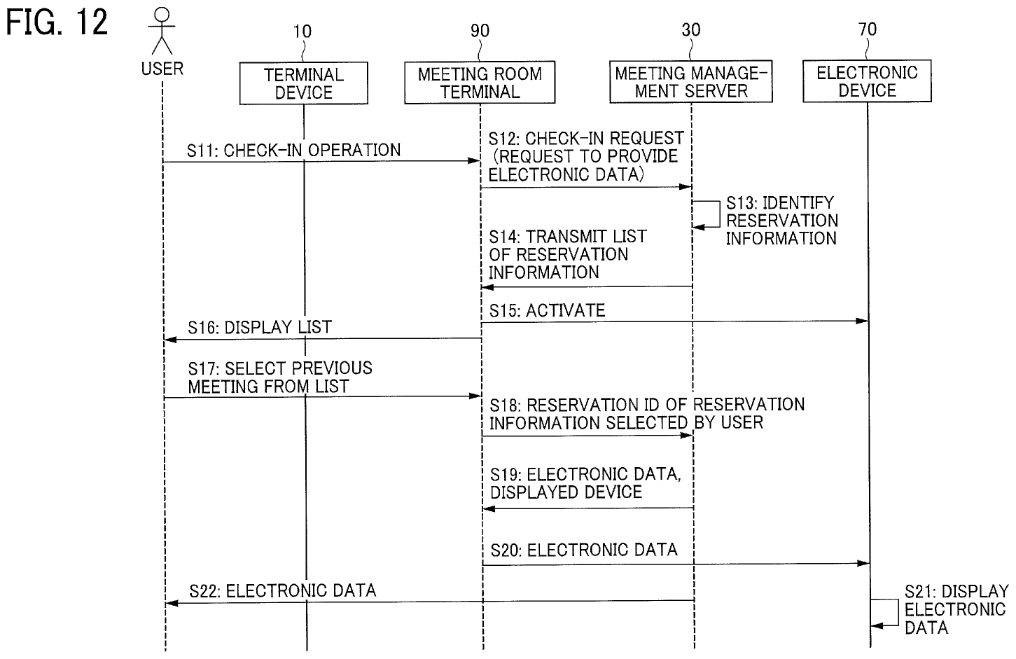

A process in which the meeting room terminal 90 acquires the electronic data at the time of check-in is described with reference to FIG. 12. FIG. 12 is a sequence diagram illustrating an example of the operation or processing of the facility reservation system when the user checks in. Note that FIG. 12 describes a case where the electronic data itself is transmitted and received as information for displaying the electronic data.

In step S11, the user presses the entry button 321 associated with the meeting room that the user has reserved or plans to participate in on the reservation status screen 300 to check-in. The operation reception unit 93 of the meeting room terminal 90 receives the press. As a result, the meeting identification information input screen is displayed, and the user inputs the meeting identification information.

In FIG. 12, the user has started using the meeting room by checking in. Alternatively, if the meeting management server 30 can confirm that the user has the authority to use the meeting room at that time, the user can start using the meeting room. For example, the user may log in to the meeting management server 30. The user inputs the user ID and password into the meeting room terminal 90, and the meeting room terminal 90 transmits the user ID and password to the meeting management server 30. When the user authentication is successful, the meeting management server 30 refers to the reservation information and determines whether the user has reserved a meeting room waiting for check-in. When the meeting room has been reserved, the usage management unit 38 permits the use of the meeting room. Note that an integrated circuit (IC) card may be used for login, or biometric authentication information may be used.

In addition, check-in may be done with an IC card prepared for the meeting room. The IC card can be picked up by the user or handed over by a receptionist when the user is successfully authenticated. The IC card contains a unique number, and the meeting room terminal 90 reads the IC card and transmits the number and the meeting room ID stored in advance to the meeting management server 30. The meeting management server 30 permits the use when the meeting room ID associated with the unique number matches the meeting room ID transmitted from the meeting room terminal 90 (assuming that the meeting room is waiting for check-in).

In step S12, the communication unit 91 of the meeting room terminal 90 designates the reservation ID, the meeting room ID, and the meeting identification information, and transmits a check-in request to the meeting management server 30. The check-in request also serves as a request to provide the electronic data. The reservation ID is an example of information related to the reservation. The reservation information can be identified by the reservation ID. The meeting room ID is identification information of the meeting room where the check-in operation was performed. The reservation information can also be identified from the meeting room ID and the current time.

In step S13, the reception unit 31b of the meeting management server 30 receives the check-in request. Here, it is assumed that the transmitted meeting identification information matches the meeting identification information stored in the meeting identification information DB 494. The usage management unit 38 permits the use of the meeting room. The information management unit 41 searches the meeting management information DB 493 with the reservation ID transmitted from the meeting room terminal 90, and identifies the reservation information (hereinafter referred to as reservation information A) of the meeting to be held. As illustrated in Table 5, the reservation information includes the reservation-making user, the meeting name, the meeting room ID, the expected participants, and the like. The information management unit 41 acquires one or more past reservation information (hereinafter referred to as reservation information B) similar to the reservation information A from the meeting management information DB 493. Examples of conditions for judging similarity are as follows.

(i) The reservation-making users are the same.

(ii) More than a certain number of participants or all participants are the same.

(iii) Part or all of the meeting name is the same.

(i) to (iii) may be combined or judged independently. However, regarding condition (i), since electronic data of past meetings can be displayed in the present embodiment, the condition (i) may be indispensable from the viewpoint of preventing information leakage. Further, regarding the conditions (ii) and (iii), when the past reservation information is repeatedly used (a certain number or more within a certain period), the information management unit 41 may determine that the similarity is satisfied. Since the display of the past electronic data is effective in the regular meeting in which the past electronic data is likely to be used in the meeting of the current day, the information management unit 41 can efficiently detect the reservation information of the regular meeting. When a plurality of electronic data are identified, the information management unit 41 identifies the electronic data with the latest date of the meeting in which the electronic data is used.

Supplementally, condition (ii) may be judged based on criteria such as, for example, 50% or more of the participants are the same, and two or more participants are the same. In addition, when the entire meeting name of the reservation information A is included in the meeting name of the reservation information B, as in the case of the “second invention discovery meeting” for the meeting name “invention discovery meeting”, it is determined that condition (iii) is satisfied. Relationship between the meeting names of the reservation information A and the reservation information B may be reversed.

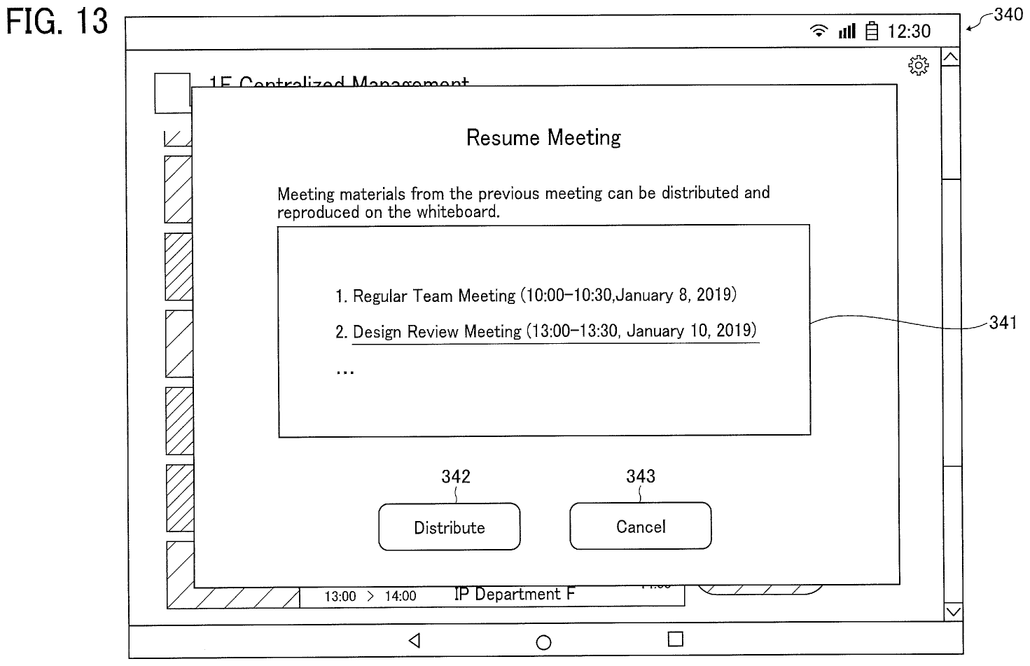

In addition, it is assumed that how long the reservation information in the past is searched for is appropriately set. For example, one year. Further, it is preferable that the user can set the period from the screen described later in FIG. 13.

In step S14, the transmission unit 31a of the meeting management server 30 transmits a list of reservation information B to the meeting room terminal 90.

In step S15, since the communication unit 91 of the meeting room terminal 90 is permitted to check-in, the electronic device communication unit 95 activates the electronic device 70 by receiving the control information. The activation may occur before check-in.

In step S16, the communication unit 91 of the meeting room terminal 90 receives the list of reservation information B. The display control unit 94 of the meeting room terminal 90 displays the list of reservation information B on the display 718. FIG. 13 illustrates an example of a list screen displaying the list of reservation information B.

In step S17, the user selects a previous meeting (meeting for which the user wants to refer to the electronic data) on the list screen. The operation reception unit 93 of the meeting room terminal 90 receives the selection. As a result, the reservation ID is designated. Since the meeting is selected from the list screen, the electronic data that the user wants to view can be displayed.

The screen of FIG. 13 may be displayed by the electronic device 70. In this case, the electronic device 70 may display the file name, thumbnail, or the like of the electronic data without displaying the list screen (for example, the electronic data of the latest meeting date is displayed). In this case, the meeting room terminal 90 transmits the electronic data and the list of the reservation information B to the electronic device 70. When the electronic data displayed by the electronic device 70 is not desired, the electronic device 70 can display the list screen by a user operation.

In step S18, the communication unit 91 of the meeting room terminal 90 designates a reservation ID and requests the meeting management server 30 for the electronic data associated with the reservation information identified by the reservation ID.

In step S19, the reception unit 31b of the meeting management server 30 receives the request for electronic data, and the information management unit 41 acquires the electronic data associated with the reservation ID and the information related to the displayed device from the electronic data DB 492. The transmission unit 31a transmits the electronic data and information related to the displayed device to the meeting room terminal 90.

In step S20, the communication unit 91 of the meeting room terminal 90 receives the electronic data and the information related to the displayed device, and transmits the electronic data to the electronic device 70 identified by the electronic device communication unit 95 based on the information related to the displayed device.

In step S21, the communication unit 71 of the electronic device 70 stores electronic data in the electronic data storage unit 77 by the electronic data sharing unit 72. The electronic data management unit 74 acquires the electronic data stored in the electronic data storage unit 77 and displays the electronic data on the display 280. As a result, the user can display the electronic data used in the past meeting on the electronic device 70 by checking in.

In step S22, the transmission unit 31a of the meeting management server 30 transmits electronic data associated with the reservation information selected by the user to the user's terminal device 60 based on the information related to the displayed device. Instead of using the information related to the displayed device, the reservation information may be sent to the email address indicated in the reservation information, or may be sent to a social networking service (SNS) through the chat server 10. As a result, when the user checks in, the meeting management server 30 can distribute the electronic data used in the past meetings to the terminal device 60 of the participating user.

FIG. 13 is an example of a reservation information list screen 340 displayed by the meeting room terminal 90. The reservation information list screen 340 includes a reservation information list 341, a distribute button 342, and a cancel button 343. The reservation information B described above is displayed in the reservation information list 341 so as to be selectable. The distribute button 342 is a button for the user to request the meeting management server 30 for the electronic data selected in the reservation information list 341. The cancel button 343 is a button for the user to input that the electronic data selected in the reservation information list is not requested from the meeting management server 30.

The user presses the distribute button 342 that selects and distributes one or more selections of the reservation information in the reservation information list 341. As a result, the user is allowed to use the electronic data used in the past meetings.

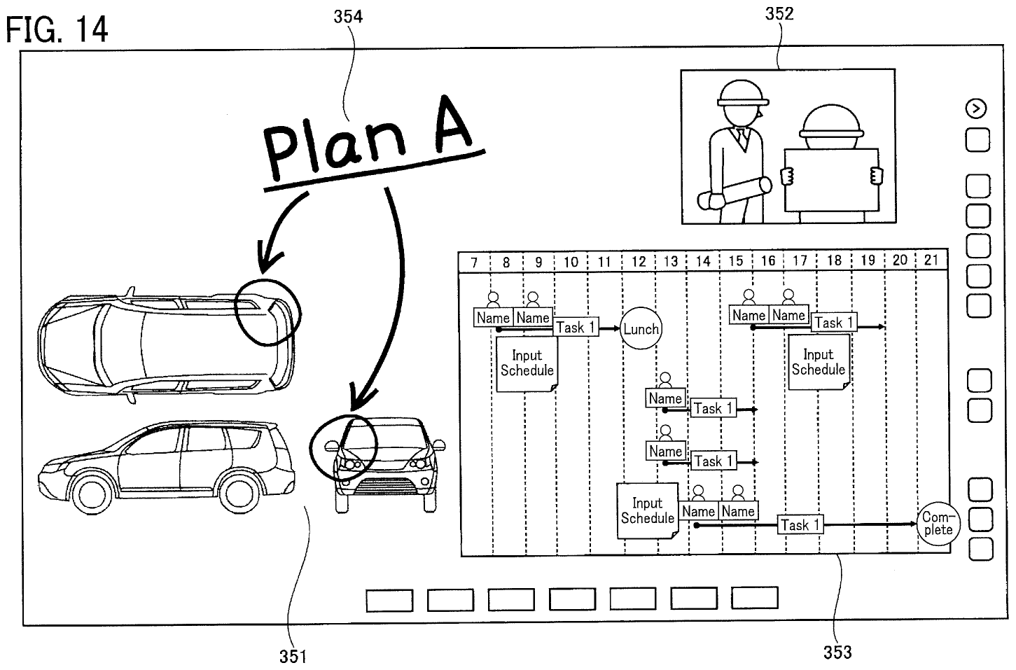

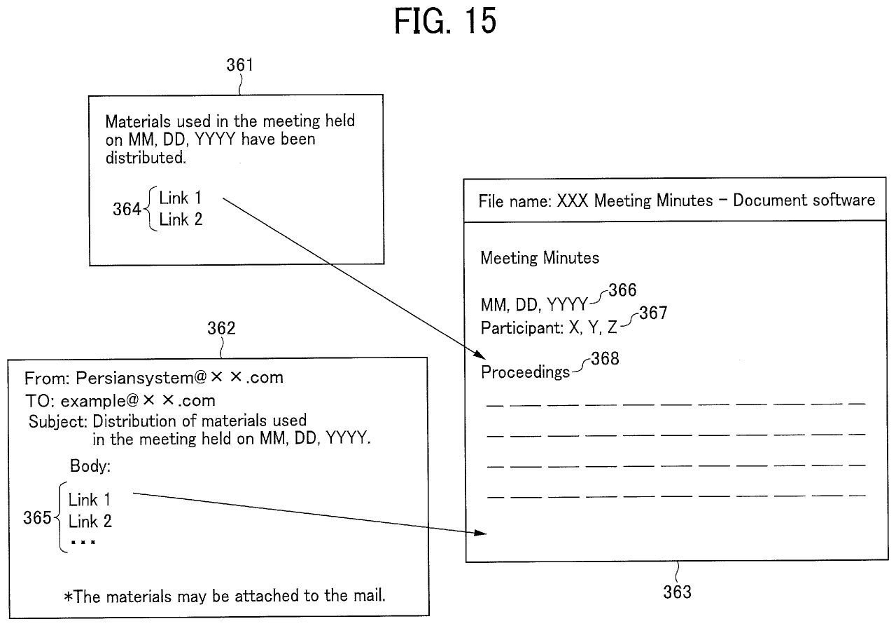

As illustrated in FIGS. 14 and 15, the electronic device 70 that has received the electronic data can display the electronic data. FIG. 14 is a diagram illustrating a display example of electronic data displayed by the electronic device 70. The electronic data in the figure is just an example, but images 351, photographs 352, material 353, handwritten data 354, and the like output by the electronic device 70 at the past meetings are displayed. One example of the format of the electronic data may be Portable Document Format (PDF). Other examples may be coordinates of display positions in the case of image 351, photograph 352, and material 353, and sequence of coordinate points, character color, thickness, line type, etc. in the case of handwritten data 354.

FIG. 15 is a diagram illustrating a display example of electronic data displayed by the terminal device 60. A notification screen 361 is displayed by the terminal device 60 when the chat application 60a is notified of the storage location of the electronic data. The display mode of the notification screen 361 may change depending on the OS of the terminal device 60. The case where the storage location of the electronic data is notified is supplemented with reference to FIG. 16. A mail screen 362 is displayed by the terminal device 60 when the storage location of the electronic data is notified by an email. One or more links 364 and 365 are displayed on the notification screen 361 and the mail screen 362. Each link indicates a storage location of electronic data by a URL or the like. When the user presses (clicks or taps) links 364 and 365, the terminal device 60 communicates with links 364 and 365 as communication destinations and receives the electronic data. When the electronic data is stored in the terminal device, links 364 and 365 indicate a storage location (path) in the user's terminal device. When the electronic data is stored in an external storage such as a cloud service, links 364 and 365 indicate a storage location in the external storage. In the case of email, electronic data may be attached as an attached file.

The electronic data is displayed by the terminal device 60, for example, on a screen 363. The electronic data displayed on the screen 363 is meeting minutes. The minutes includes the date of the meeting 366, the participants 367, and the proceedings 368.

In FIG. 12, the electronic data itself is transmitted from the meeting management server 30 to the meeting room terminal 90. Alternatively, the storage location of the electronic data (information for displaying the electronic data) may be transmitted from the meeting management server to the meeting room terminal 90.

FIG. 16 is a sequence diagram illustrating a modification example of the operation or processing of the facility reservation system when the user checks in. In the description of FIG. 16, differences from FIG. 12 is mainly described. The processes of steps S11 to S18 may be the same as in FIG. 12.

In step S19, the reception unit 31b of the meeting management server 30 receives the electronic data request, and the information management unit 41 acquires the electronic data associated with the reservation ID from the electronic data DB 492. The transmission unit 31a transmits a URL indicating a storage location where the electronic data is stored to the meeting room terminal 90. The URL indicating the storage location may be on the network, on-premises, or on the internet.

In step S25, the communication unit 91 of the meeting room terminal 90 receives the URL of the electronic data, and the electronic device communication unit 95 transmits the URL of the electronic data to the electronic device 70.

In step S25-2, the communication unit 71 of the electronic device 70 receives the URL of the electronic data, and the communication unit 71 connects to the URL to acquire the electronic data. The communication unit 71 stores the acquired electronic data in the electronic data storage unit 77.

In step S26, the electronic data management unit 74 acquires the electronic data stored in the electronic data storage unit 77 and displays the electronic data on the display 280. As a result, the user can display the electronic data used in the past meeting on the electronic device 70 by checking in.

In step S27, the transmission unit 31a of the meeting management server 30 transmits the URL of the electronic data associated with the reservation information selected by the user to the user's terminal device 60. The user operates the terminal device 60 to connect to the URL of the electronic data and acquires the electronic data used in the past meetings.

By transmitting the URL of the electronic data instead of the electronic data, the communication load can be reduced, and the electronic device 70 can display the electronic data quickly.

As described above, the facility reservation system of the present embodiment can provide the user with the electronic data used in the past meetings by the user who checked in to the meeting room. The user can check-in by a simple operation (check-in) and further display the electronic data. Since the meeting room terminal 90 displaying the entry button (display part) is waiting for check-in, it is also possible to prevent the display of electronic data by a user who is not related to the meeting.

In the second embodiment, the facility reservation system 100 in which the electronic device 70 stores the electronic data is described. When a regular meeting is held in a fixed meeting room, the electronic device 70 provided in the meeting room can display electronic data without communicating with other devices.

In the present embodiment, the hardware configuration diagrams of FIGS. 3 to 5 and the functional block diagrams illustrated in FIGS. 6A, 6B, 7A, 7B, and 8 described in the above embodiment are applicable.

In the present embodiment, the contents of the electronic data table stored in the electronic data DB 492 illustrated in Table 4 are partially different.

TABLE 12
Electronic Data DB

| Reservation ID | Meeting room ID | Displayed device | Password |
|---|---|---|---|
| 001 | K-001 | electronic whiteboard | **** |
| 002 | K-001 | projector | **** |
| . . . | . . . | . . . | . . . |

Table 12 is an example of electronic data table stored in the electronic data DB 492. In the electronic data DB 492 of the present embodiment, the meeting room ID, the displayed device, and the password are stored in association with the reservation ID. The electronic data and the information for displaying the electronic data are not stored in the electronic data DB 492. The password is confidential information for only the user who participated in the meeting to display the electronic data. The leakage of electronic data can be prevented in the electronic device 70 operated by an unspecified user by the password.

Further, in the present embodiment, since the electronic device 70 holds the electronic data, the electronic data storage unit 77 of the electronic device 70 stores an information table as illustrated in Table 13.

TABLE 13
Electronic Data Storage

| Reservation ID | Meeting room ID | Electronic data |
|---|---|---|
| 001 | K-001 | whiteboard.pdf |
| | | sample.doc |
| 002 | K-002 | abc.pdf |
| | | xyz.jpeg |
| . . . | . . . | . . . |

Table 13 is an example of electronic data table stored in the electronic data storage unit 77. The meeting room ID and the electronic data are stored in association with the reservation ID in the electronic data storage unit 77. The electronic data is encrypted with the password in Table 12. In the present embodiment, the storage location of the electronic data is a prefixed folder, and it is preferable that the file name is also set to include the reservation ID. As a result, the electronic data management unit 74 can acquire the electronic data based on the reservation ID. In addition, the user can also identify the meetings that the user has participated in the past by the file name from a file browser or the like, and display the electronic data used in the past meetings.

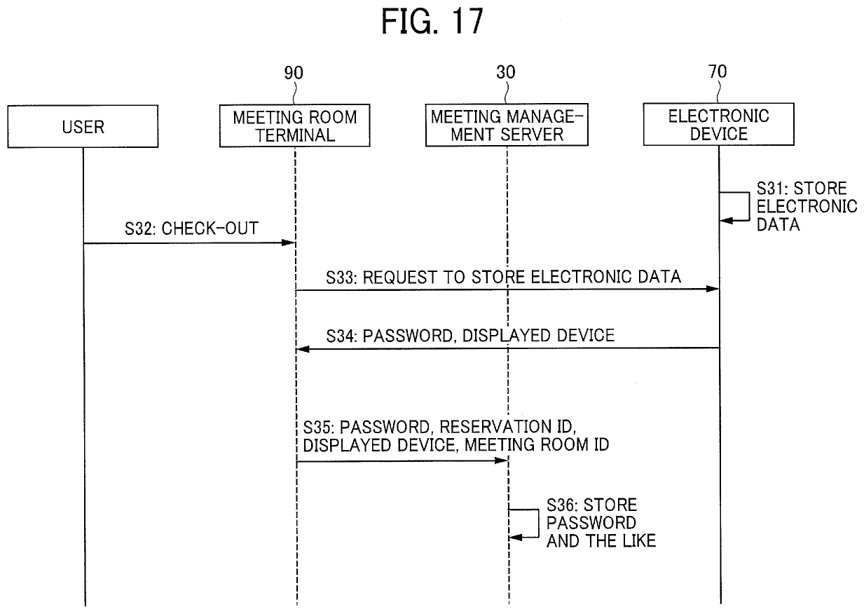

FIG. 17 is a sequence diagram illustrating an example of an operation or process performed by the facility reservation system 100 when a user checks out. The check-in process is described below. In the description of FIG. 17, the difference from FIG. 11 is mainly described.

The storage of electronic data in step S31 may be the same as in step S1 of FIG. 11.

In step S32, the user presses the exit button 323 associated with the meeting room in which the user is having a meeting on the reservation status screen. The operation reception unit 93 of the meeting room terminal 90 receives the press.

In step S33, the electronic device communication unit 95 of the meeting room terminal 90 requests the electronic device 70 to store the electronic data used during the meeting by designating the reservation ID. In the present embodiment, since the electronic data storage unit 77 also stores the electronic data of the past meetings, only the electronic data of the meeting on the current day needs to be stored. As a result, it is possible to reduce the pressure on the storage capacity of the electronic device 70. The electronic device 70 may store the electronic data on the network.

In step S34, the communication unit 71 of the electronic device 70 receives the electronic data storage request, and the electronic data management unit 74 randomly generates a password. The electronic data management unit 74 encrypts the electronic data of the current day with a password and stores the encrypted data in association with the reservation ID. The communication unit 71 transmits the password and information related to the displayed device to the meeting room terminal 90. Since the electronic device 70 holds the electronic data, the information related to the displayed device does not have to be transmitted. Alternatively, when there are a plurality of electronic devices 70 and each electronic device 70 stores electronic data, the electronic device 70 transmits information related to the displayed device.

In step S35, the electronic data collection unit 97 of the meeting room terminal 90 receives the password and information related to the displayed device through the electronic device communication unit 95, and the communication unit 91 transmits the password, the information related to the displayed device, the reservation ID, and the meeting room ID to the meeting management server 30. The check-out is notified to the meeting management server 30 as in FIG. 11.

The meeting room terminal 90 may display a password on the display 718. If the user makes a note, the electronic data can be displayed by entering the password into the electronic device 70 at the time of check-in at a later date.

In step S36, the reception unit 31b of the meeting management server 30 receives the password, the information related to the displayed device, the reservation ID, and the meeting room ID and the information management unit 41 stores the password, the information reservation ID related to the displayed device, and the meeting room ID in the electronic data DB 492. The meeting management server 30 may send the password to the user's email address. The electronic data can be displayed by the user entering the password into the electronic device 70 at the check-in at a later date.

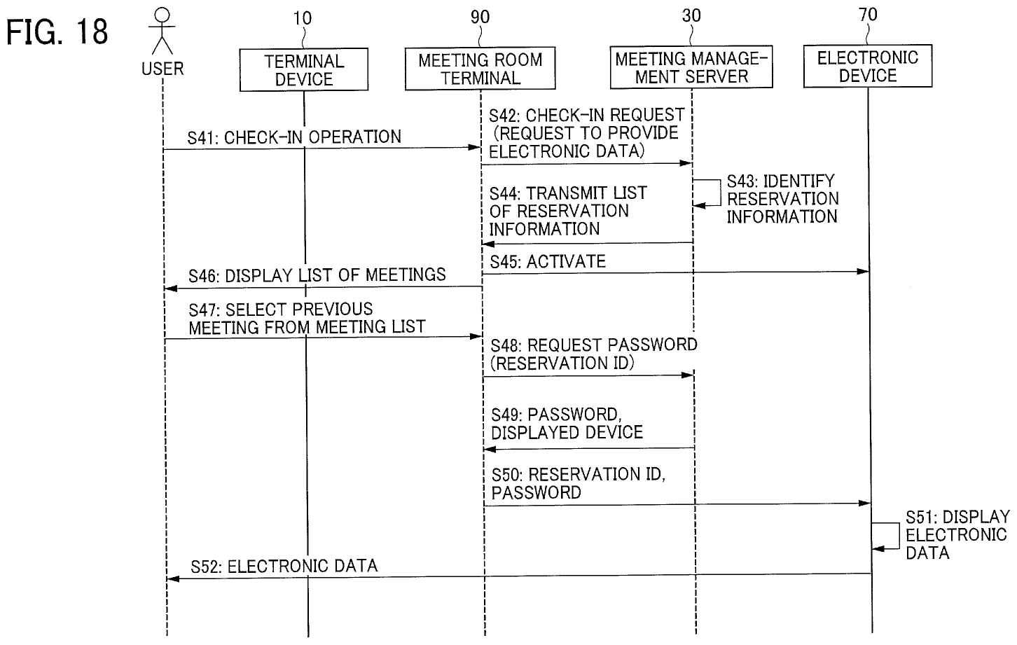

A process in which the meeting room terminal 90 acquires the electronic data at the check-in is described with reference to FIG. 18. FIG. 18 is a sequence diagram illustrating an example of the operation or processing of the facility reservation system 100 when the user checks in. In the description of FIG. 18, the difference from FIG. 12 is mainly described. Steps S41 to S47 may be the same as steps S1 to S7 in FIG. 12.

In step S48, the communication unit 91 of the meeting room terminal 90 designates a reservation ID and requests the meeting management server 30 for the password associated with the reservation ID.

In step S49, the reception unit 31b of the meeting management server 30 receives the password request, and the information management unit 41 acquires the password associated with the reservation ID from the electronic data DB 492. The transmission unit 31a transmits the password to the meeting room terminal 90.

In step S50, the communication unit 91 of the meeting room terminal 90 receives the password, and the electronic device communication unit 95 transmits the reservation ID and the password to the electronic device 70.

In step S51, the communication unit 71 of the electronic device 70 receives the reservation ID and password, and the electronic data management unit 74 searches for the reservation ID stored in the electronic data storage unit 77. When the reservation ID is found, the electronic data associated with the reservation ID is decrypted with the password. The electronic data display unit 73 displays the electronic data on the display 280. As described above, in the present embodiment, the electronic data can be displayed on the electronic device 70 side.

The check-in confirms that the user is the person who registered the reservation information of the meeting room reserved at the current time. Therefore, the user has the authority to browse the reservation information similar to the current reservation information of the meeting room.

The electronic device 70 after activation may display an electronic data selection screen. The user selects the electronic data of the meetings in which the user has participated in the past using a file browser or the like. The electronic device 70 that has received the selection displays the password input screen and the user inputs the password that the user wrote down or received by email or the like. As a result, the user can also display the electronic data before the electronic device 70 receives the password.

In step S52, the user operates and connects the terminal device 60 to the electronic device 70 and the terminal device 60 can display the electronic data.

As described above, in the present embodiment, the electronic device 70 can store the electronic data and display the electronic data with the password. Even if the user does not check-in, the user can display the electronic data by the password. Further, since the electronic device 70 stores the electronic data, the communication load can be reduced.

The above-described embodiments are illustrative and do not limit the present invention. Thus, numerous additional modifications and variations are possible in light of the above teachings within the scope of the present invention. Any one of the above-described operations may be performed in various other ways, for example, in an order different from the one described above.

For example, in the present embodiments, the meeting management server 30 mainly provides the electronic data of the meetings held in the past, but the meeting management server 30 may provide the electronic data of the meetings held in parallel.

A plurality of meeting management servers 30 may exist, or the functions of the meeting management server 30 may be distributed to a plurality of servers. Further, the reservation management server 20 and the meeting management server 30 may be integrated.

The apparatuses or devices described in the present embodiments are merely one example of plural computing environments that implement one or more embodiments disclosed herein. In some embodiments, meeting management server 30 includes multiple computing devices, such as a server cluster. The plurality of computing devices are configured to communicate with one another through any type of communication link, including a network, shared memory, etc., and perform the processes disclosed herein.

The facility reservation system 100 of the present embodiments can also be referred to as a “web service”. The web service refers to various services provided by the internet-related technologies. Examples of the web service include various rental services such as a meeting room rental service. A system that uses the service is called a usage system.

In addition, the functional configuration of the facility reservation system 100 are divided into the functional blocks as illustrated in FIGS. 6A, 6B, 7A, 7B, and 8, for example, based on main functions thereof, in order to facilitate understanding the processes performed by the facility reservation system 100. No limitation is intended by how the processes are divided or by the name of the processes. The facility reservation system100 can also be divided into the larger number of units according to the processing contents. Further, one processing unit can be divided so as to include more processing.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A facility reservation system comprising:
an information processing apparatus configured to manage a facility reservation schedule; and
an information processing terminal configured to receive operation related to use of a facility,
the information processing terminal including:
first circuitry configured to transmit, to the information processing apparatus, a request to start using the facility, the request designating information related to a reservation of the facility to be used in response to receiving an operation to start using the facility, and
the information processing apparatus including:
second circuitry configured to:
permit start of use of the facility in response to receiving the request to start using the facility;
identify electronic data output during the use of the facility based on the information related to the reservation of the facility, in response to permitting the start of use of the facility; and
transmit information for displaying the electronic data to the information processing terminal.

2. The facility reservation system of claim 1, wherein the second circuitry is further configured to:
identify reservation information related to the reservation of the facility based on the information related to the reservation of the facility; and
transmit a list of the reservation information that is identified to the information processing terminal, and
the first circuitry is further configured to:
display on a display, the list of the reservation information;
receive selection of reservation information from the list of the reservation information of the facility; and
request the information processing apparatus to provide the electronic data, designating the reservation information that is selected, and
the second circuitry is further configured to
transmit information for displaying the electronic data associated with the designated reservation information to the information processing terminal.

3. The facility reservation system of claim 1, wherein the second circuitry is further configured to:
identify past reservation information similar to reservation information of the facility identified by the information related to the reservation of the facility,
wherein the information for displaying the electronic data is associated with the identified reservation information.

4. The facility reservation system of claim 3, wherein
the past reservation information includes a reservation-making user same as a reservation-making user of the reservation information of the facility, and more than a certain number of participants same as participants of the reservation information of the facility.

5. The facility reservation system of claim 3, wherein
the past reservation information includes a reservation-making user having a name that is same as a name of a reservation-making user included in the reservation information of the facility to be used, and a conference name that is partly same as a conference name of the reservation information of the facility.

6. The facility reservation system of claim 2, wherein
the second circuitry is configured to transmit the electronic data associated with the reservation information as the information for displaying the electronic data, to the information processing terminal.

7. The facility reservation system of claim 2, wherein
the second circuitry is configured to transmit a uniform resource locator (URL) indicating a storage location of the electronic data associated with the reservation information as the information for displaying the electronic data, to the information processing terminal.

8. The facility reservation system of claim 2, wherein
the second circuitry is configured to transmit a password associated with the reservation information as the information for displaying the electronic data, to the information processing terminal.

9. The facility reservation system of claim 6, wherein
the second circuitry is configured to transmit the information related to a device that displayed the electronic data during the use of the facility in addition to the information for displaying the electronic data, to the information processing terminal, and
the first circuitry is configured to transmit information for displaying the electronic data to an electronic device identified by information related to the device that displayed the electronic data during use of the facility.

10. The facility reservation system of claim 1, wherein
the first circuitry is further configured to:
request an electronic device for information for displaying the electronic data in response to receiving an operation for terminating the use of the facility; and
transmit the information for displaying the electronic data received from the electronic device to the information processing apparatus, and
the second circuitry is further configured to associate received information for displaying the electronic data with reservation information of the facility.

11. An information processing terminal for communicating through a network with an information processing apparatus that manages a facility reservation schedule, the information processing terminal comprising:
circuitry configured to:
transmit to the information processing apparatus, a request to start using a facility, the request designating information related to a reservation of the facility in response to receiving an operation to start using the facility;
obtain permission to start using the facility in response to receiving the operation to start using the facility; and
receive from the information processing apparatus information for displaying electronic data output during use of the facility, identified based on the information related to the reservation of the facility.

12. An information processing apparatus for communicating through a network with an information processing, the information processing apparatus comprising:
circuitry configured to:
receive a request to start using the facility transmitted from the information processing terminal, the request designating information related to a reservation of the facility;
permit start of use of the facility in response to receiving the request to start using the facility;
identify electronic data output during the use of the facility based on the information related to the reservation of the facility in response to permitting the start of use of the facility; and
transmit information for displaying the electronic data to the information processing terminal.
